(19) United States
(12) Patent Application Publication
(10) Pub. No.: US 2005/0157949 A1
(43) Pub. Date: Jul. 21, 2005

(54) Generation of still image

(76) Inventors: Seiji Aiso, Nagano-ken (JP); Kenji Matsuzaka, Nagano-ken (JP)

Correspondence Address: Peter B. Martine;MARTINE & PENILLA, LLP, Suite 170, 710 Lakeway Drive, Sunnyvale, CA, 94085, US

(21) Appl. No.: 10/954,027

(22) Filed: Sep. 28, 2004

(30) Foreign Application Priority Data
Sep. 30, 2003 (JP) 2003-339915
Oct. 30, 2003 (JP) 2003-370279

(51) Int. Cl. G06K 9/32; G06K 9/36

(52) U.S. Cl. 382/299; 382/294; 382/284

(57) ABSTRACT

A still image generation apparatus of the invention includes an image acquisition module that obtains multiple first image data arrayed in a time series among multiple lower-resolution image data, an image storage module that stores the multiple first image data obtained by the image acquisition module, and a correction rate estimation module that estimates correction rates for eliminating positional shifts between images of the respective first image data, based on the multiple first image data stored in the image storage module. The still image generation apparatus further includes an image composition module that corrects the multiple first image data with the estimated correction rates to eliminate the positional shifts between the images of the respective first image data, and combines the multiple corrected first image data to generate higher-resolution second image data as resulting still image data. This arrangement of the invention desirably shortens the total processing time in the process of combining multiple image data.

### BACKGROUND OF THE INVENTION

1. Field of the Invention

The present invention relates to a still image generation apparatus that generates relatively high-resolution still image data from multiple relatively low-resolution image data, as well as to a corresponding still image generation method, a corresponding still image generation program, and a recording medium in which the still image generation program is recorded.

2. Description of the Related Art

Moving picture data taken by, for example, a digital video camera consists of multiple relatively low-resolution image data (for example, frame image data). A conventional still image generation technique extracts lower-resolution frame image data from moving picture data and generates higher-resolution still image data from the extracted frame image data.

There are several methods applicable to enhance the resolution of the frame image data and generate the higher-resolution still image data. One available method is simple resolution enhancement of obtained one frame image data according to a known interpolation technique, such as the bicubic technique or the bilinear technique. Another available method obtains multiple frame image data from moving picture data and enhances the resolution simultaneously with combining the obtained multiple frame image data. Here the terminology ‘resolution’ means the density of pixels or the number of pixels included in one image.

The known relevant techniques of generating still image data include, for example, that disclosed in Japanese Patent Laid-Open Gazettes No. 11-164264 and No. 2000-244851. The technique disclosed in these cited references selects one frame image as a base frame image among (n+1) consecutive frame images, computes motion vectors of the residual n frame images (subject frame images) relative to the base frame image, and combines the (n+1) frame images based on the computed motion vectors to generate one high-resolution image.

Various moving pictures are taken by digital video cameras. There are thus diverse images expressed by frame image data obtained from the moving picture data. Some images have practically no motions (for example, landscape), while other images have significantly varying motions (for example, a soccer game) and still other images have intermediate motions. Here the terminology ‘motion’ means a localized motion in an image and represents a movement of a certain subject in the image.

There may be a demand to obtain images with practically no motions and images with significantly varying motions as multiple frame image data from moving picture data and generate high-resolution still image data. In order to meet this demand, the user is expected to select an adequate method for each image by trial and error among the multiple available resolution enhancement methods mentioned above.

This imposes a rather heavy burden on the user and requires a relatively long time for selecting the adequate resolution enhancement methods for the respective images.

This problem is not intrinsic to resolution enhancement of multiple low-resolution frame image data obtained from moving picture data but is also found in resolution enhancement of any multiple low-resolution image data arrayed in a time series.

### SUMMARY OF THE INVENTION

The object of the invention is thus to eliminate the drawbacks of the prior art and to provide a technique of readily selecting an adequate resolution enhancement method for each image among multiple available resolution enhancement methods.

In order to attain at least part of the above and the other related objects, the present invention is directed to a still image generation apparatus that generates higher-resolution second image data, which represents a resulting still image, from multiple lower-resolution first image data. The still image generation apparatus includes: a shift correction module that corrects the multiple first image data to eliminate a positional shift between images of the multiple first image data; a motion detection module that detects a motion in each of the images of the multiple first image data, based on comparison of the multiple corrected first image data; and a resolution enhancement process selection module that selects one resolution enhancement process among multiple available resolution enhancement processes according to a result of the detection.

This arrangement does not require the user to select an adequate resolution enhancement process by trial and error.

The present invention is also directed to another still image generation apparatus that generates higher-resolution second image data, which represents a resulting still image, from multiple lower-resolution first image data. The still image generation apparatus includes: a shift correction module that corrects the multiple first image data to eliminate a positional shift between images of the multiple first image data; a motion detection module that compares base image data set as a standard with at least one subject image data other than the base image data among the multiple corrected first image data, detects each localized motion in a subject image expressed by the at least one subject image data relative to a base image expressed by the base image data, and calculates a motion rate as a total sum of localized motions over the whole subject image; and a resolution enhancement process selection module that selects one resolution enhancement process among multiple available resolution enhancement processes according to the calculated motion rate.

This arrangement also does not require the user to select an adequate resolution enhancement process by trial and error.

In one preferable embodiment of the invention, the still image generation apparatus further includes a resolution enhancement module that is capable of executing the multiple available resolution enhancement processes, and executes the selected resolution enhancement process to generate the higher-resolution second image data from the multiple corrected lower-resolution first image data.

This arrangement does not require the user to select an adequate resolution enhancement process by trial and error, but ensures automatic execution of the adequate resolution enhancement process according to the motions of the image to generate high-quality still image data.

In another preferable embodiment of the invention, the still image generation apparatus further includes a notification module that notifies a user of the selected resolution enhancement process as a recommendation of resolution enhancement process.

The user is informed of the recommendation of the resolution enhancement process given by the still image generation apparatus. The user can thus freely select a desired resolution enhancement process by taking into account the recommendation.

The multiple first image data may be multiple image data that are extracted from moving picture data and are arrayed in a time series.

The relatively high-resolution second image data can thus be generated readily as still image data from the multiple relatively low-resolution first image data included in the moving picture data.

In one preferable embodiment of the still image generation apparatus, the motion detection module detects a motion or no motion of each pixel included in the subject image relative to the base image, and calculates the motion rate from a total number of pixels detected as a pixel with motion.

The total sum of the localized motions over the whole subject image is determined with high accuracy as the number of pixels detected as the pixel with motion.

In the still image generation apparatus of this embodiment, it is preferable that the motion detection module sequentially sets each pixel in the subject image as an object pixel or an object of motion detection in the subject image relative to the base image, sets an object range of the motion detection based on a pixel value of a nearby pixel in the base image that is located near to the object pixel, and detects the object pixel as the pixel with motion when a pixel value of the object pixel is within the object range, while detecting the object pixel as a pixel with no motion when the pixel value of the object pixel is out of the object range.

In the still image generation apparatus of this embodiment, it is also preferable that the motion detection module sequentially sets each pixel in the subject image as an object pixel or an object of motion detection in the subject image relative to the base image, estimates an assumed pixel to have an identical pixel value with a pixel value of the object pixel based on a pixel value of a nearby pixel in the base image that is located near to the object pixel, and detects the object pixel as the pixel with motion when a distance between the object pixel and the assumed pixel is greater than a preset threshold value, while detecting the object pixel as a pixel with no motion when the distance is not greater than the preset threshold value.

In another preferable embodiment of the still image generation apparatus, the motion detection module computes a motion value of each pixel in the subject image, which represents a degree of motion of the pixel in the subject image relative to the base image, and calculates the motion rate from a total sum of the computed motion values.

The total sum of the localized motions over the whole subject image is determined with high accuracy as the total sum of the computed motion values representing the degree of motion.

In the still image generation apparatus of this embodiment, it is preferable that the motion detection module sequentially sets each pixel in the subject image as an object pixel or an object of motion detection in the subject image relative to the base image, sets a reference pixel value based on a pixel value of a nearby pixel in the base image that is located near to the object pixel, and computes a difference between a pixel value of the object pixel and the reference pixel value as the motion value of the object pixel.

In the still image generation apparatus of this embodiment, it is also preferable that the motion detection module sequentially sets each pixel in the subject image as an object pixel or an object of motion detection in the subject image relative to the base image, estimates an assumed pixel to have an identical pixel value with a pixel value of the object pixel based on a pixel value of a nearby pixel in the base image that is located near to the object pixel, and computes a distance between the object pixel and the assumed pixel as the motion value of the object pixel.

The present invention is further directed to another still image generation apparatus that generates higher-resolution second image data, which represents a resulting still image, from multiple lower-resolution first image data. The still image generation apparatus includes: a motion detection module that compares base image data set as a standard with at least one subject image data other than the base image data among the multiple first image data, detects a motion or a no motion in a subject image expressed by the at least one subject image data relative to a base image expressed by the base image data with regard to each of multiple blocks obtained by dividing the subject image, and determines a motion rate, which represents a degree of motion in the whole subject image relative to the base image, based on a result of the motion detection; and a resolution enhancement process selection module that selects one resolution enhancement process among multiple available resolution enhancement processes according to the determined motion rate.

This arrangement also does not require the user to select an adequate resolution enhancement process by trial and error.

In one preferable embodiment of the invention, the still image generation apparatus further includes a resolution enhancement module that executes the selected resolution enhancement process to generate the second image data from the multiple first image data.

This arrangement does not require the user to select an adequate resolution enhancement process by trial and error, but ensures automatic execution of the adequate resolution enhancement process according to the motions of the image to generate high-quality still image data.

In another preferable embodiment of the invention, the still image generation apparatus further includes a notification module that notifies a user of the selected resolution enhancement process as a recommendation of resolution enhancement process.

The user is informed of the recommendation of the resolution enhancement process given by the still image generation apparatus. The user can thus freely select a desired resolution enhancement process by taking into account the recommendation.

The present invention is also directed to another still image generation apparatus that generates higher-resolution second image data, which represents a resulting still image, from multiple lower-resolution first image data. The still image generation apparatus includes: a motion detection module that compares base image data set as a standard with at least one subject image data other than the base image data among the multiple first image data, detects a motion or a no motion in a subject image expressed by the at least one subject image data relative to a base image expressed by the base image data with regard to each of multiple blocks obtained by dividing the subject image, and determines an in-block motion rate of each block of the subject image, which represents a degree of motion in the block of the subject image relative to a corresponding block of the base image, based on a result of the motion detection; a resolution enhancement process selection module that selects one resolution enhancement process for each block among multiple available resolution enhancement processes according to the determined in-block motion rate; and a resolution enhancement module that executes the resolution enhancement process selected for each block, so as to generate the second image data representing the block of the resulting still image from the multiple first image data.

The still image generation apparatus of this application automatically selects and executes an adequate resolution enhancement process for an image portion having localized motions, while automatically selecting and executing another adequate resolution enhancement process for an image portion having practically no motions. This arrangement effectively processes an image having localized motions to generate high-quality still image data.

The resolution enhancement process selection module selects one resolution enhancement process for each block among multiple available resolution enhancement processes according to the determined in-block motion rate. The resolution enhancement process selection module may select one resolution enhancement process for each pixel included in each block among multiple available resolution enhancement processes according to the determined in-block motion rate.

In one preferable embodiment of the invention, the still image generation apparatus further includes a shift detection module that detects a first positional shift of the whole subject image relative to the base image and second positional shifts of respective blocks included in the subject image relative to corresponding blocks of the base image. The motion detection module detects a motion in a specified block, based on the detected first positional shift of the whole subject image and the detected second positional shift of the specified block.

This arrangement detects the motions of the subject image not in units of pixels but in larger units and thereby desirably shortens the total processing time.

In one preferable embodiment of the still image generation apparatus, the motion detection module detects a motion or no motion of each pixel included in a specified block of the subject image relative to a corresponding block of the base image, and detects a motion in the specified block, based on a total number of pixels detected as a pixel with motion.

This arrangement reflects the motions of the respective pixels on detection of the motion in each block, thus ensuring accurate motion detection.

In another preferable embodiment of the still image generation apparatus, the motion detection module computes a motion value of each pixel in a specified block of the subject image, which represents a magnitude of motion of the subject image relative to the base image, and detects a motion in the specified block, based on a total sum of the computed motion values.

This arrangement reflects the motions of the respective pixels on detection of the motions in each block, thus ensuring accurate motion detection.

In the still image generation apparatus of the invention, it is preferable that the motion detection module calculates the motion rate from a total number of blocks detected as a block with motion. It is also preferable that the motion detection module calculates the motion rate from a total sum of magnitudes of motions detected in respective blocks.

In the still image generation apparatus of the invention, the multiple first image data may be multiple image data that are extracted from moving picture data and are arrayed in a time series. The second image data representing a resulting still image can thus be generated readily from the multiple first image data included in the moving picture data.

The technique of the invention is not restricted to the still image generation apparatuses described above, but is also actualized by corresponding still image generation methods, computer programs that actualize these apparatuses or methods, recording media in which such computer programs are recorded, data signals that include such computer programs and are embodied in carrier waves, and diversity of other adequate applications.

In the applications of the computer programs and the recording media in which the computer programs are recorded, each computer program may be constructed as a whole program of controlling the operations of the still image generation apparatus or as a partial program of exerting only the essential functions of the invention.

### BRIEF DESCRIPTION OF THE DRAWINGS

FIG. 1 schematically illustrates the configuration of a still image generation apparatus in a first embodiment of the invention;

FIG. 2 is a flowchart showing a still image data generation process;

FIG. 3 shows a positional shift of a subject frame image in a subject frame relative to a base frame image in a base frame;

FIG. 4 shows correction executed to eliminate the positional shift of the subject frame image relative to the base frame image;

FIG. 5 shows composition of a base frame image Fr and a subject frame image Ft corrected to eliminate a positional shift therebetween;

FIG. 6 shows setting for description of a motion detection method;

FIG. 7 shows the motion detection method adopted in the first embodiment of the invention;

FIG. 8 shows superposition of corrected subject frame images F1 to F3 on a base frame image F0 after elimination of the positional shift;

FIG. 9 shows interpolation by the bilinear method;

FIG. 10 shows a result of motion non-follow-up composition in the case of a significant level of motions between multiple frame images;

FIG. 11 shows a motion detection process in motion rate detection method 1;

FIG. 12 shows determination of a motion rate in motion rate detection method 2;

FIG. 13 shows determination of the motion rate in motion rate detection method 3;

FIG. 14 is a flowchart showing a resolution enhancement process in response to the user's selection;

FIG. 15 shows a preview window notifying the user of the recommended resolution enhancement process;

FIG. 16 shows a base frame image and subject frame images respectively divided into 12 blocks in a third embodiment of the invention;

FIGS. 17(A), (B), and (C) show the outline of a motion rate detection process executed in the third embodiment of the invention;

FIGS. 18(A) and 18(B) show computation of distances used for correction in a block No. 1 of a subject frame image F1;

FIG. 19 is an enlarged view showing the block No. 1 of the corrected subject frame image F1 after correction with estimated correction rates ub1, vb1, and δb1 to eliminate a positional shift of the block No. 1 of the subject frame image F1 relative to a corresponding block No. 1 of a base frame image F0;

FIG. 20 shows computation of a relative distance M in the block No. 1 of the subject frame image F1 relative to the block No. 1 in the base frame image F0;

FIG. 21 shows superposition of corrected subject frame images F1 to F3 on a base frame image F0 after elimination of the positional shift;

FIG. 22 shows interpolation by the bilinear method;

FIG. 23 shows a result of motion non-follow-up composition in the case of a significant level of motions between multiple frame images;

FIG. 24 shows setting for description of the motion detection method executed in the third embodiment of the invention;

FIG. 25 shows the motion detection method adopted in the third embodiment of the invention;

FIG. 26 is a flowchart showing a still image data generation process executed in a fourth embodiment of the invention; and

FIG. 27 shows computation of a motion value in a block No. 1 of a subject frame image F1 executed in a seventh embodiment of the invention.

### DESCRIPTION OF THE PREFERRED EMBODIMENTS

Some modes of carrying out the invention are described below as preferred embodiments in the following sequence:
1. First Embodiment
   1-A. Configuration of Still Image Generation Apparatus
   1-B. Still Image Generation Process
      1-B-1. Correction Rate Estimation Process
      1-B-2. Motion Rate Detection Process
      1-B-3. Selection of Resolution Enhancement Process
      1-B-4. Resolution Enhancement Process
         1-B-4-1. Motion Non-Follow-Up Composition
         1-B-4-2. Motion Follow-Up Composition
         1-B-4-3. Simple Resolution Enhancement
   1-C. Other Motion Rate Detection Methods
      1-C-1. Motion Rate Detection Method 1
      1-C-2. Motion Rate Detection Method 2
      1-C-3. Motion Rate Detection Method 3
   1-D. Effects
2. Second Embodiment
3. Third Embodiment
   3-A. Still Image Generation Process
      3-A-1. Motion Rate Detection Process
      3-A-2. Selection of Resolution Enhancement Process
      3-A-3. Resolution Enhancement Process
         3-A-3-1. Motion Non-Follow-Up Composition
         3-A-3-2. Motion Follow-Up Composition
         3-A-3-3. Simple Resolution Enhancement
   3-B. Effects
4. Fourth Embodiment
5. Fifth Embodiment
6. Sixth Embodiment
7. Seventh Embodiment
8. Modifications

### 1. First Embodiment

A. Configuration of Still Image Generation Apparatus

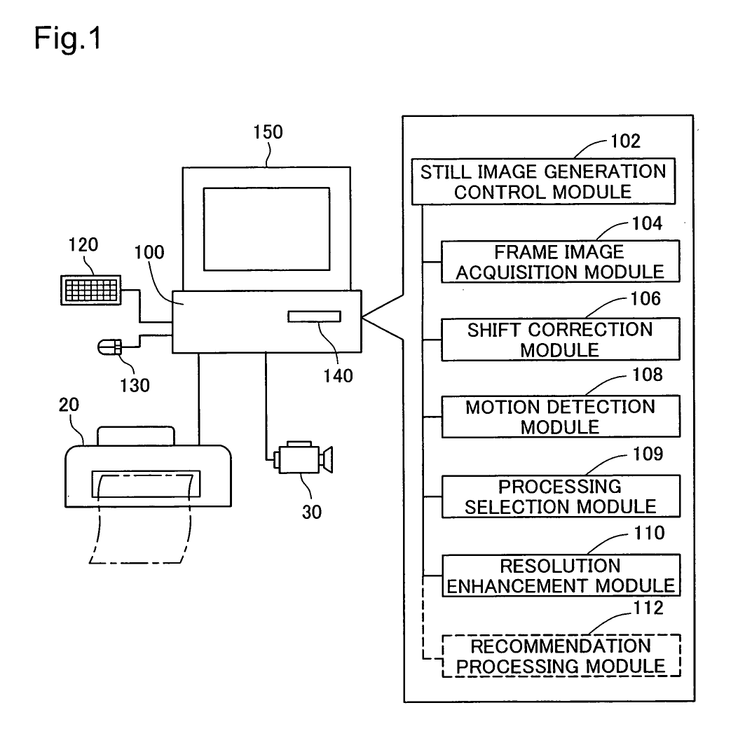

FIG. 1 schematically illustrates the configuration of a still image generation apparatus in a first embodiment of the invention. The still image generation apparatus is constructed by a general-purpose personal computer 100 and is connected with a keyboard 120 and a mouse 130 as information input devices and a display 150 and a printer 20 as information output devices. The still image generation apparatus is also connected with a digital video camera 30 and a CD-R/RW drive 140 to input moving picture data to the computer 100. The moving picture data input device connected with the still image generation apparatus is not restricted to the CD-R/RW drive but may be a DVD drive and any other drive units of reading data from diversity of information storage media.

In the specification hereof, an image expressed by frame image data is called a frame image. The frame image represents a still image that is expressible in a non-interlace format.

The computer 100 executes an application program of generating still images under a preset operating system to function as the still image generation apparatus. As illustrated, the computer 100 exerts the functions of a still image generation control module 102, a frame image acquisition module 104, a shift correction module 106, a motion detection module 108, a processing selection module 109, and a resolution enhancement module 110. A recommendation processing module 112 will be discussed later with reference to a modified example.

The still image generation control module 102 controls the respective devices to generally regulate the still image generation operations. For example, in response to the user's entry of a video reproduction command from the keyboard 120 or the mouse 130, the still image generation control module 102 reads moving picture data from a CD-RW set in the CD-R/RW drive 140, the digital video camera 30, or a hard disk (not shown) into an internal memory (not shown). The moving picture data includes multiple frame image data respectively representing still images. The still images expressed by the frame image data of respective frames are successively shown on the display 150 via a video driver, so that a moving picture is shown on the display 150. The still image generation control module 102 controls the operations of the frame image acquisition module 104, the misalignment correction module 106, the motion detection module 108, the processing selection module 109, and the resolution enhancement module 110 to generate relatively high-resolution still image data from relatively low-resolution frame image data of one or multiple frames. The still image generation control module 102 also controls the printer 20 via a printer driver to print the generated still image data.

1-B. Still Image Generation Process

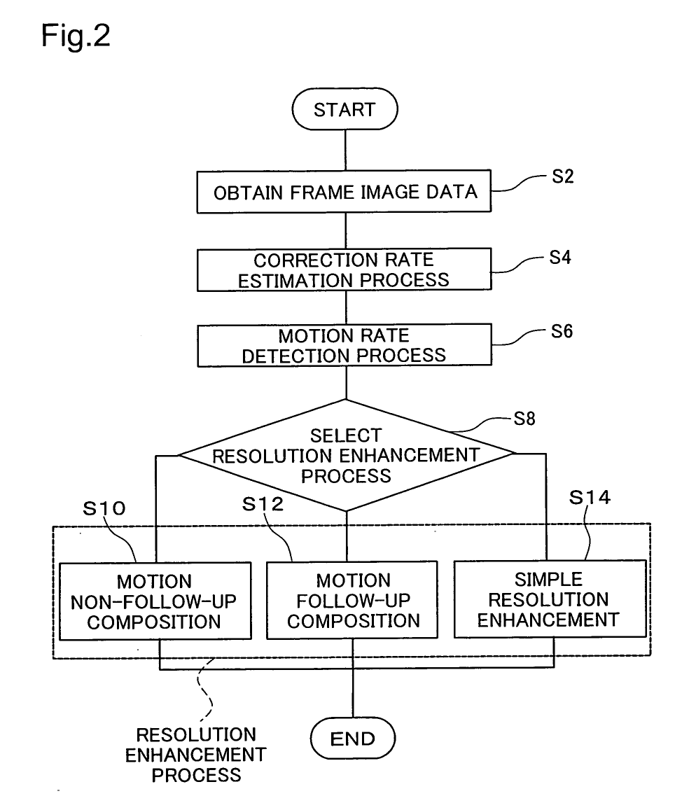

FIG. 2 is a flowchart showing a still image data generation process. In response to the user's entry of a frame image data acquisition command from the keyboard 120 or the mouse 130 during reproduction of a moving picture, the frame image acquisition module 104 obtains frame image data of multiple consecutive frames in a time series among the moving picture data (step S2). For example, the procedure of this embodiment obtains frame image data of four consecutive frames in a time series after the input timing of the frame image data acquisition command. The multiple frame image data selected by the frame image acquisition module 104 are stored in a storage device (not shown), such as the memory or the hard disk.

The frame image data consists of tone data (pixel data) representing tone values (pixel values) of respective pixels in a dot matrix. The pixel data may be YCbCr data of Y (luminance), Cb (blue color difference), and Cr (red color difference) components or RGB data of R (red), G (green), and B (blue) color components.

In response to the user's entry of a still image generation command from the keyboard 120 or the mouse 130, the procedure starts a still image data generation process.

The shift correction module 106 estimates correction rates to eliminate positional shifts between the obtained four consecutive frames (step S4). The correction rate estimation process specifies one frame among the four consecutive frames as a base frame and the other three frames as subject frames and estimates correction rates to eliminate positional shifts of the respective subject frames relative to the base frame. The procedure of this embodiment specifies an initial frame obtained first in response to the user's entry of the frame image data acquisition command as the base frame and the three consecutive frames obtained successively in the time series as the subject frames. The details of the correction rate estimation process are discussed below.

1-B-1. Correction Rate Estimation Process

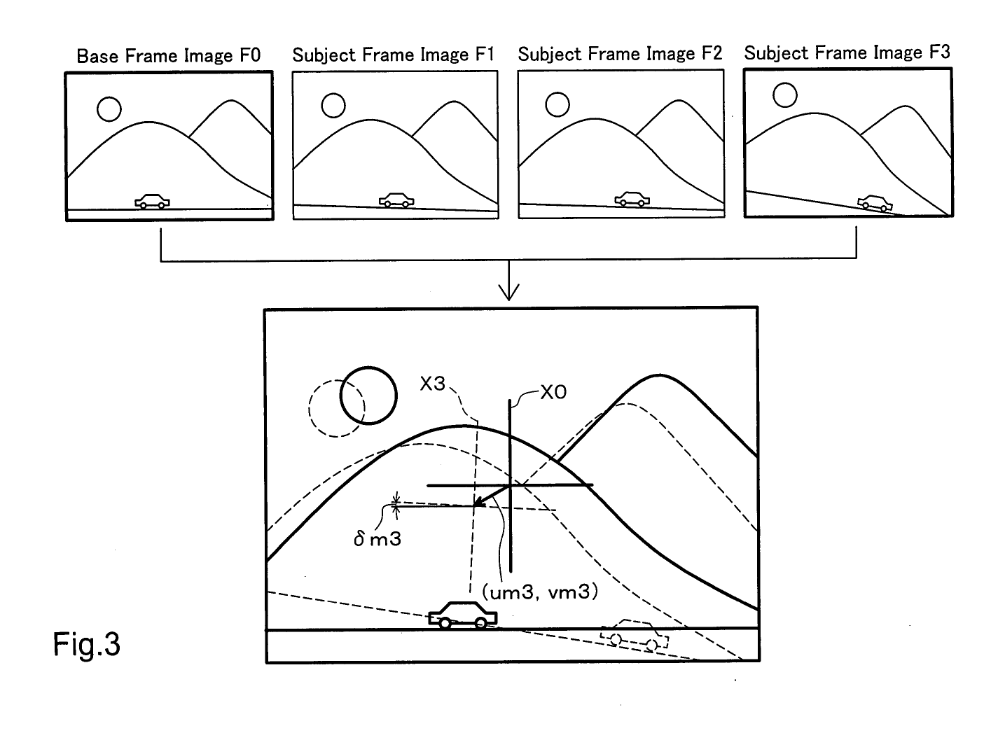

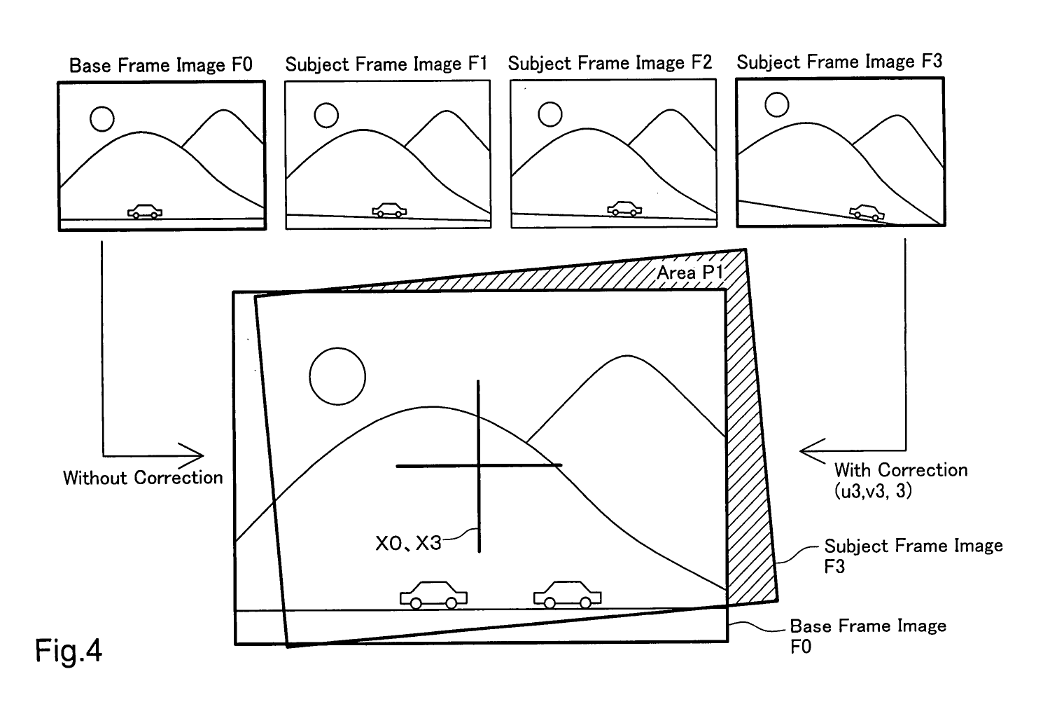

The description regards positional shifts of subject frame images in subject frames relative to a base frame image in a base frame with reference to FIG. 3, correction executed to eliminate the positional shifts with reference to FIG. 4, and estimation of correction rates to correct the subject frame images in this order. FIG. 3 shows a positional shift of a subject frame image in a subject frame relative to a base frame image in a base frame. FIG. 4 shows correction executed to eliminate the positional shift of the subject frame image relative to the base frame image.

In the description below, a number (frame number) ‘a’ (a=0, 1, 2, 3) is allocated to each of the obtained four consecutive frames. A frame ‘a’ represents a frame with the frame number ‘a’ allocated thereto. An image in the frame ‘a’ is called a frame image Fa. For example, the frame with the frame number ‘a’=0 is a frame 0 and the image in the frame 0 is a frame image F0. The frame 0 is the base frame and frames 1 to 3 are the subject frames. The frame image F0 in the base frame is the base frame image, while frame images F1 to F3 in the subject frames are the subject frame images.

A positional shift of the image is expressed by a combination of translational (lateral and vertical) shifts and a rotational shift. For the clear and better understanding of a positional shift of the subject frame image F3 relative to the base frame image F0, the boundary of the subject frame image F3 is superposed on the boundary of the base frame image F0 in FIG. 3. A virtual cross image X0 is added on the center position of the base frame image F0. On the assumption that the cross image X0 is shifted in the same manner as the subject frame image F3, a shifted cross image X3 is added on the subject frame image F3. For the clarity of illustration, the base frame image F0 and the virtual cross image X0 are shown by thick solid lines, whereas the subject frame image F3 and the shifted cross image X3 are shown by the thin broken lines.

In this embodiment, translational shifts in the lateral direction and in the vertical direction are respectively represented by ‘um’ and ‘vm’, and a rotational shift is represented by ‘δm’. The positional shifts of the subject frame images Fa (a=1, 2, 3) are accordingly expressed as ‘uma’, ‘vma’, and ‘δma’. In the illustrated example of FIG. 3, the subject frame image F3 has translational shifts and a rotational shift relative to the base frame image F0, which are expressed as ‘um3’, ‘vm3’, and ‘δm3’.

Prior to composition of the subject frame images F1 to F3 with the base frame image F0, correction of positional differences of respective pixels included in the subject frame images F1 to F3 is required to eliminate the positional shifts of the subject frame images F1 to F3 relative to the base frame image F0. Translational correction rates in the lateral direction and in the vertical direction are respectively represented by ‘u’ and ‘v’, and a rotational correction rate is represented by ‘δ’. The correction rates of the subject frame images Fa (a=1, 2, 3) are accordingly expressed as ‘ua’, ‘va’, and ‘′δa’. For example, correction rates of the subject frame image F3 are expressed as ‘u3’, ‘v3’, and ‘δ3’.

The terminology ‘correction’ here means that the position of each pixel included in each subject frame image Fa (a=1, 2, 3) is moved by a distance ‘ua’ in the lateral direction, a distance ‘va’ in the vertical direction, and a rotation angle ‘δa’. The correction rates ‘ua’, ‘va’, and ‘δa’ are thus expressed by equations ‘ua=−uma’, ‘va=−vma’, and ‘δa=−δma’. For example, the correction rates ‘u3’, ‘v3’, and ‘δ3’ of the subject frame image F3 are expressed by equations ‘u3=−um3’, ‘v3=−vm3’, and ‘δ3==δm3’.

The correction process of FIG. 4 corrects the position of each pixel included in the subject frame image F3 with the correction rates ‘u3’, ‘v3’, and ‘δ3’ to eliminate the positional shift of the subject frame image F3 relative to the base frame image F0. FIG. 4 shows superposition of the corrected subject frame image F3 over the base frame image F0 on the display 140. The corrected subject frame image F3 partly matches with the base frame image F0. For the better understanding of the result of the correction, the virtual cross images X0 and X3 used in FIG. 3 are also added on the display of FIG. 4. The correction results in eliminating the positional difference between the two virtual cross images X0 and X3 and perfectly matching the positions of the two virtual cross images X0 and X3 with each other as clearly seen in FIG. 4.

In a similar manner, the correction process corrects the other subject frame images F1 and F2 with the correction rates ‘u1’, ‘v1’, and ‘δ1’ and ‘u2’, ‘v2’, and ‘δ2’ to move the positions of the respective pixels included in the subject frame images F1 and F2.

The expression ‘partly match’ is used here because of the following reason. In the illustrated example of FIG. 4, a hatched image area P1 is present only in the subject frame image F3, and the base frame image F0 does not have a corresponding image area. The positional shift causes an image area that is present only in the base frame image F0 or that is present only in the subject frame image F3. The correction can thus not perfectly match the subject frame image F3 with the base frame image F0 but gives only a partial matching effect.

The shift correction module 106 (see FIG. 1) computes the correction rates ‘ua’, ‘va’, and ‘δa’ of the respective subject frame images Fa (a=1, 2, 3) as estimated values from the image data of the base frame image F0 and the image data of the subject frame images F1 to F3 according to preset calculation formulae of the pattern matching method, the gradient method, or the least-squares method. The computed correction rates ‘ua’, ‘va’, and ‘δa’ are stored as translational correction rate data and rotational correction rate data in a predetermined area of the memory (not shown).

In the structure of this embodiment, the shift correction module 106 executes correction with the estimated correction rates to eliminate the positional shifts of the subject frame images F1 to F3 relative to the base frame image F0. The resolution enhancement module 110 executes one of three available resolution enhancement processes discussed later to generate still image data. The suitability of any of the three resolution enhancement processes depends upon the rate of ‘motions’ in the frame images. As mentioned previously, the user has difficulties in selecting an adequate process among the three available resolution enhancement processes for each image. The procedure of this embodiment determines a rate of motions (motion rate) in the frame images and selects an adequate process among the three available resolution enhancement processes according to the detected motion rate. The following describes the motion rate detection process executed in this embodiment. The three available resolution enhancement processes selectively executed according to the result of the motion rate detection process will be discussed later.

1-B-2. Motion Rate Detection Process

On completion of the correction rate estimation process (step S4 in FIG. 2), a motion rate detection process is executed (step S6 in FIG. 2). The motion rate detection process detects motions of the respective subject frame images F1 to F3 relative to the base frame image F0 and determines their motion rate on the premise of correction of the subject frame images F1 to F3 to eliminate the positional shifts of the subject frame images F1 to F3 relative to the base frame image F0.

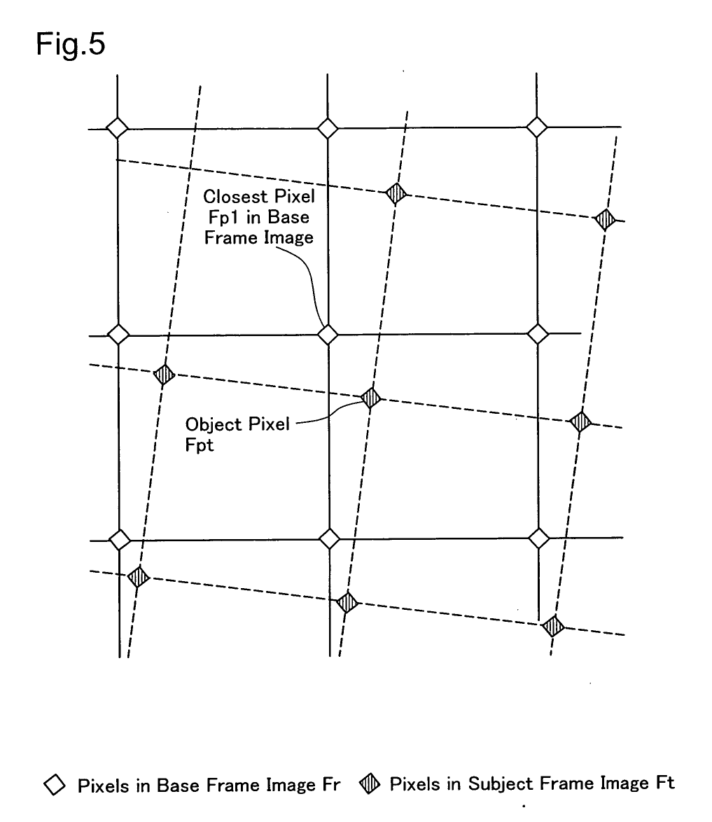

In the following simplified explanation of the motion rate detection process, Fr and Ft respectively denote a base frame image and a subject frame image. FIG. 5 shows composition of the base frame image Fr and the subject frame image Ft corrected to eliminate a positional shift therebetween. In the illustration of FIG. 5, open boxes represent pixels included in the base frame image Fr, and hatched boxes represent pixels included in the corrected subject frame image Ft. A pixel Fpt on the approximate center of the illustration is an object of motion detection (hereafter referred to as the object pixel). A nearby pixel Fp1 in the base frame image Fr is a closest pixel to the object pixel Fpt.

The shift correction module 106 executes the correction rate estimation process (step S4 in FIG. 2) to estimate a correction rate and eliminate a positional shift of the subject frame image Ft relative to the base frame image Fr with the estimated correction rate, and superposes the corrected subject frame image Ft on the base frame image Fr as shown in FIG. 5. The motion detection module 108 specifies an object pixel Fpt in the subject frame image Ft and detects a nearby pixel Fp1 in the base frame image Fr closest to the specified object pixel Fpt. The motion detection module 108 then detects a motion or no motion of the specified object pixel Fpt, based on the detected nearby pixel Fp1 in the base frame image Fr and adjacent pixels in the base frame image Fr that adjoin to the detected nearby pixel Fp1 and surround the object pixel Fpt. The method of motion detection is described below in detail.

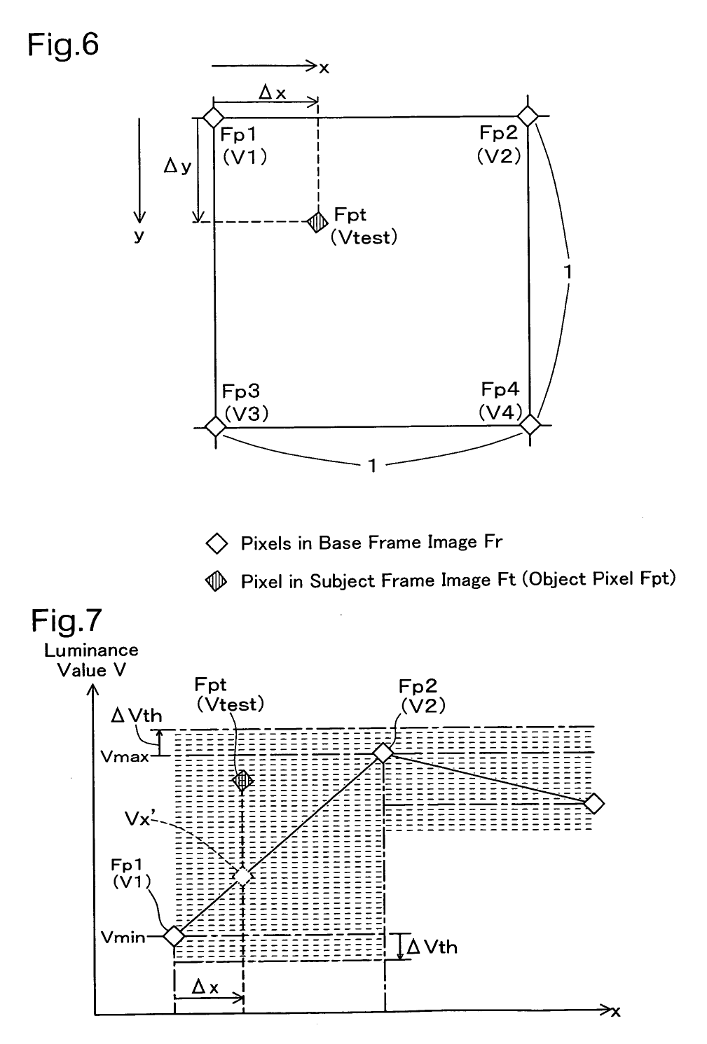

FIG. 6 shows setting for description of the motion detection method. One hatched box in FIG. 6 represents the object pixel Fpt included in the subject frame image Ft. Four open boxes arranged in a lattice represent four pixels Fp1, Fp2, Fp3, and Fp4 in the base frame image Fr to surround the object pixel Fpt. The pixel Fp1 is closest to the object pixel Fpt as mentioned above. The object pixel Fpt has a luminance value Vtest, and the four pixels Fp1, Fp2, Fp3, and Fp4 respectively have luminance values V1, V2, V3, and V4. A position (Δx,Δy) in the lattice defined by the four pixels Fp1, Fp2, Fp3, and Fp4 is expressed by coordinates in a lateral axis ‘x’ and in a vertical axis ‘y’ in a value range of 0 to 1 relative to the position of the upper left pixel Fp1 as the origin.

For the simplicity of explanation with reference to FIG. 7, it is assumed that the object pixel Fpt has a one-dimensional position in the lattice and is expressed by coordinates (Δx,0) between the two pixels Fp1 and Fp2 aligned in the axis ‘x’.

FIG. 7 shows the motion detection method adopted in this embodiment. The object pixel Fpt in the subject frame image Ft is expected to have an intermediate luminance value between the luminance values of the adjoining pixels Fp1 and Fp2 in the base frame image Fr, unless there is a spatially abrupt change in luminance value. Based on such expectation, a range between a maximum and a minimum of the luminance values of the adjoining pixels Fp1 and Fp2 close to the object pixel Fpt is assumed as a no-motion range. In order to prevent a noise-induced misdetection, the assumed no-motion range may be extended by the width of a threshold value ΔVth. The motion detection module 108 determines the presence or the absence of the luminance value Vtest of the object pixel Fpt in the assumed no-motion range and thereby detects a motion or no motion of the object pixel Fpt.

The motion detection module 108 first computes a maximum Vmax and a minimum Vmin of the luminance values of the two pixels Fp1 and Fp2 in the base frame image Fr adjoining to the object pixel Fpt according to equations given below:
Vmax=max(V1,V2)
Vmin=min(V1,V2)
where max( ) and min( ) respectively represent a function of determining a maximum among the elements in the brackets and a function of determining a minimum among the elements in the brackets.

The object pixel Fpt is detected as a pixel with motion when the luminance value Vtest of the object pixel Fpt satisfies the following two relational expressions, while otherwise being detected as a pixel with no motion:
Vtest>Vmin−ΔVth
Vtest<Vmax+ΔVth

In the description below, the assumed no-motion range is also referred to as the target range. In this example, a range of Vmin−ΔVth<V<Vmax+ΔVth between the adjoining pixels to the object pixel Fpt is the target range.

In the example described above, the object pixel Fpt is assumed to have the coordinates (Δx,0) relative to the position of the pixel Fp1 in the base frame image Fr as the origin. The description is similarly applied to the object pixel Fpt having the coordinates (0,Δy). With regard to the object pixel Fpt having the two dimensional coordinates (Δx,Δy), the maximum Vmax and the minimum Vmin of the luminance values are given by:
Vmax=max(V1,V2,V3,V4)
Vmin=min(V1,V2,V3,V4)

The motion detection module 108 detects the motion of each object pixel Fpt in the above manner and repeats this motion detection with regard to all the pixels included in the subject frame image Ft. For example, the motion detection may start from a leftmost pixel on an uppermost row in the subject frame image Ft, sequentially run to a rightmost pixel on the uppermost row, and successively run from leftmost pixels to rightmost pixels on respective rows to terminate at a rightmost pixel on a lowermost row. Pixels that are included in the corrected subject frame image Ft partially matched with the base frame image Fr as the result of correction of eliminating the positional shift but are not present on the base frame image Fr should be excluded from the object pixel Fpt of the motion detection.

On completion of the motion detection with regard to all the pixels included in the subject frame image Ft, the motion detection module 108 counts the number of pixels detected as the pixel with motion in the subject frame image Ft.

The motion detection module 108 counts the number of pixels detected as the pixel with motion in each of the three subject frame images F1 to F3 and sums up the counts to determine a total sum of pixels Rm detected as the pixel with motion in the three subject frame images F1 to F3. The motion detection module 108 also counts a total number of pixels Rj specified as the object pixel of the motion detection in the three subject frame images F1 to F3 and calculates a rate Re(=Rm/Rj) of the total sum of pixels Rm detected as the pixel with motion to the total number of pixels Rj. The rate Re represents a degree of motions in the subject frame images relative to the base frame image and is thus used as the motion rate described above.

1-B-3. Selection of Resolution Enhancement Process

On completion of the motion rate detection process (step S6 in FIG. 2), an adequate resolution enhancement process is selected (step S8 in FIG. 2). The procedure of this embodiment compares the motion rate Re obtained in the motion detection process (step S6 in FIG. 2) with preset threshold values Rt1 and Rt2(1>Rt1>Rt2>0) and selects an adequate resolution enhancement process according to the result of the comparison.

The processing selection module 109 first compares the obtained motion rate Re with the preset threshold value Rt1. When the motion rate Re is greater than the preset threshold value Rt1(Re≧Rt1), simple resolution enhancement (discussed later) is selected on the assumption of a significant level of motions in the image. When the motion rate Re is not greater than the preset threshold value Rt1(Re≦Rt1), the processing selection module 109 subsequently compares the motion rate Re with the preset threshold value Rt2. When the motion rate Re is greater than the preset threshold value Rt2(Re>Rt2), motion follow-up composition (discussed later) is selected on the assumption of an intermediate level of motions in the image. When the motion rate Re is not greater than the preset threshold value Rt2(Re≦Rt2), motion non-follow-up composition (discussed later) is selected on the assumption of practically no motions in the image.

In one example, it is assumed that the preset threshold values Rt1 and Rt2 are respectively set equal to 0.8 and to 0.2. When the motion rate Re is greater than 0.8, the simple resolution enhancement technique is selected. When the motion rate Re is greater than 0.2 but is not greater than 0.8, the motion follow-up composition technique is selected. When the motion rate Re is not greater than 0.2, the motion non-follow-up composition technique is selected.

1-B-4. Resolution Enhancement Process

After selection of the adequate resolution enhancement process (step S8 in FIG. 2), the selected resolution enhancement process is executed (steps S10 to S14 in FIG. 2).

The resolution enhancement module 110 executes the adequate resolution enhancement process selected among the three available resolution enhancement processes (that is, motion non-follow-up composition, motion follow-up composition, and simple resolution enhancement) by the processing selection module 109.

1-B-4-1. Motion Non-Follow-Up Composition

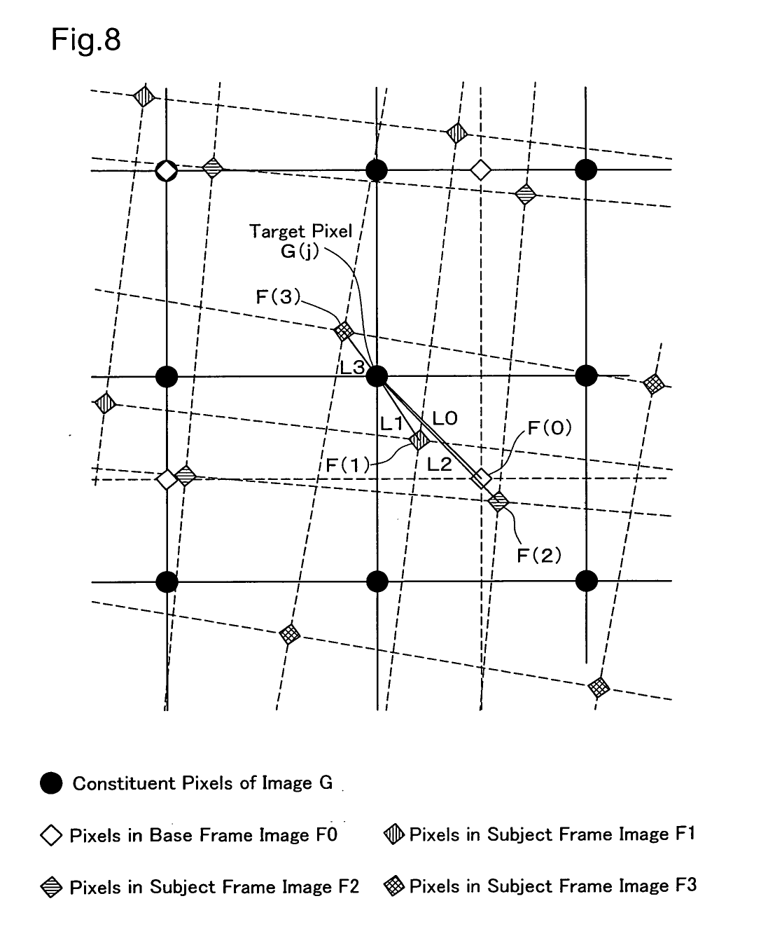

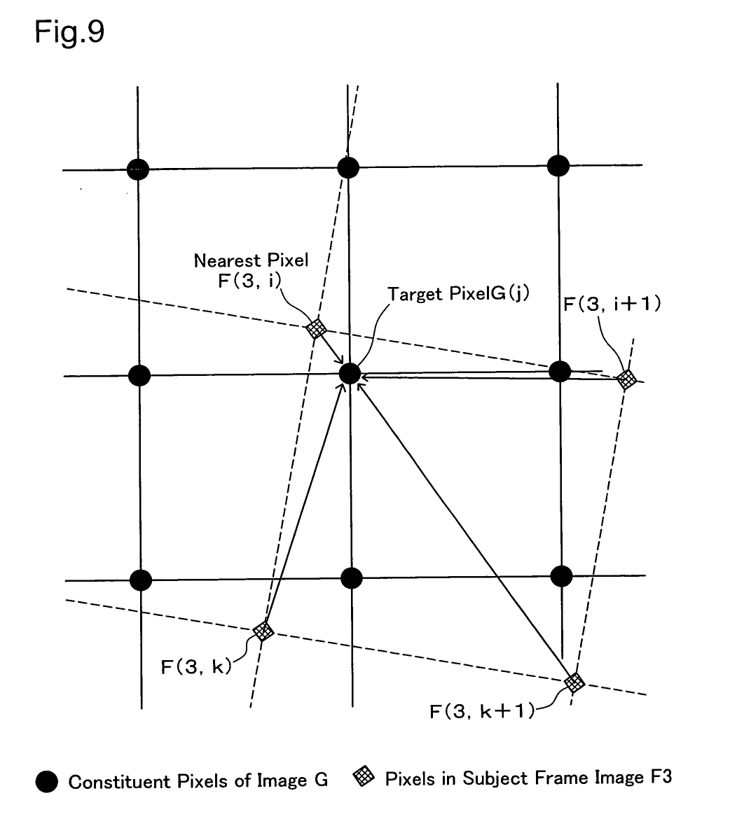

The process of motion non-follow-up composition (step S10 in FIG. 2) is described first. In the process of motion non-follow-up composition, the shift correction module 106 corrects the subject frame image data with the estimated correction rates obtained in the correction rate estimation process (step S4 in FIG. 2) to eliminate the positional shift of the subject frame image data relative to the base frame image data. The resolution enhancement module 110 then enhances the resolution simultaneously with superposition of the corrected subject frame image data on the base frame image data to generate still image data. The resolution enhancement module 110 applies a preset interpolation to pixels that are not in the base frame image nor in the subject frame images among pixels constituting a resulting still image (hereafter referred to as ‘constituent pixels’). The preset interpolation uses pixel data representing pixel values of surrounding pixels that are present in the vicinity of the constituent pixels (that is, tone data representing tone values) and attains enhancement of the resolution simultaneously with composition of the subject frame images with the base frame image. The motion non-follow-up composition is described briefly with reference to FIGS. 8 and 9.

FIG. 8 shows superposition of the corrected subject frame images F1 to F3 on the base frame image F0 after elimination of the positional shift. In the illustration of FIG. 8, closed circles, open boxes, and hatched boxes respectively represent constituent pixels of a resulting image G, pixels included in the base frame image F0, and pixels included in the corrected subject frame images F1 to F3. In this illustrated example, the pixel density of the resulting image G is increased to 1.5 times in both length and width relative to the pixel density of the base frame image F0. The constituent pixels of the resulting image G are positioned to overlap the pixels of the base frame image F0 at intervals of every two pixel positions. The positions of the constituent pixels of the resulting image G are, however, not restricted to those overlapping the pixels of the base frame image F0 but may be determined according to various requirements. For example, all the pixels of the resulting image G may be located in the middle of the respective pixels of the base frame image F0. The rate of the resolution enhancement is not restricted to 1.5 times in length and width but may be set arbitrarily according to the requirements.

The following description mainly regards a certain pixel G(j) included in the resulting image G. A variable ‘j’ gives numbers allocated to differentiate all the pixels included in the resulting image G. For example, the number allocation may start from a leftmost pixel on an uppermost row in the resulting image G, sequentially go to a rightmost pixel on the uppermost row, and successively go from leftmost pixels to rightmost pixels on respective rows to terminate at a rightmost pixel on a lowermost row. The resolution enhancement module 110 selects a pixel having the shortest distance (hereafter referred to as ‘nearest pixel’) to the certain pixel G(j) (hereafter referred to as ‘target pixel G(j)’).

The resolution enhancement module 110 detects neighbor pixels (adjacent pixels) F(0), F(1), F(2), and F(3) of the respective frame images F0, F1, F2, and F3 adjoining to the target pixel G(j), computes distances L0, L2, L2, and L3 between the detected adjacent pixels F(0), F(1), F(2), and F(3) and the target pixel G(j), and determines the nearest pixel. In the illustrated example of FIG. 8, L3<L1<L0<L2. The resolution enhancement module 110 thus selects the pixel F(3) of the subject frame image F3 as the nearest pixel to the target pixel G(j). The nearest pixel to the target pixel G(j) is hereafter expressed as F(3,i), which means the i-th pixel in the subject frame image F3.

The resolution enhancement module 110 repeatedly executes this series of processing with regard to all the constituent pixels included in the resulting image G in the order of the numbers of the target pixel G(j), where j=1, 2, 3 . . . to select nearest pixels to all the constituent pixels.

The resolution enhancement module 110 then generates pixel data of each target pixel G(j) from pixel data of the selected nearest pixel and pixel data of other pixels in the frame image including the selected nearest pixel, which surround the target pixel G(j), by any of diverse interpolation techniques, for example, the bilinear method, the bicubic method, or the nearest neighbor method. The interpolation by the bilinear method is described below.

FIG. 9 shows interpolation by the bilinear method. The target pixel G(j) is not present in any of the base frame image F0 and the corrected subject frame images F1 to F3 after elimination of the positional shift. The target pixel G(j) accordingly has no pixel data. In response to selection of the adjacent pixel F(3) of the subject frame image F3 as the nearest pixel F(3,i) to the target pixel G(j), the resolution enhancement module 110 draws a virtual area defined by three other pixels F(3,i+1), F(3,k), F(3,k+1) in the subject frame image F3 surrounding the target pixel G(j), as well as the nearest pixel F(3,i) as shown in FIG. 9. The resolution enhancement module 110 then divides the virtual area into four divisions by the target pixel G(j), multiplies the pixel data at the respective diagonal positions by preset weights corresponding to the area ratio, and sums up the weighted pixel data to interpolate the pixel data of the target pixel G(j). Here k represents a number allocated to a pixel that is adjacent to the i-th pixel in the lateral direction of the subject frame image F3.

As described above, the motion non-follow-up composition makes interpolation of each target pixel with pixel data of surrounding pixels in a frame image including a selected nearest pixel, among the base frame image and the subject frame images. This technique ensures resolution enhancement simultaneously with composition and gives a significantly high-quality still image.

The motion non-follow-up composition technique is especially suitable for a very low motion rate of the subject frame images relative to the base frame image.

This is because the motion non-follow-up composition may cause a problem discussed below in the presence of significant motions of the subject frame images relative to the base frame image.

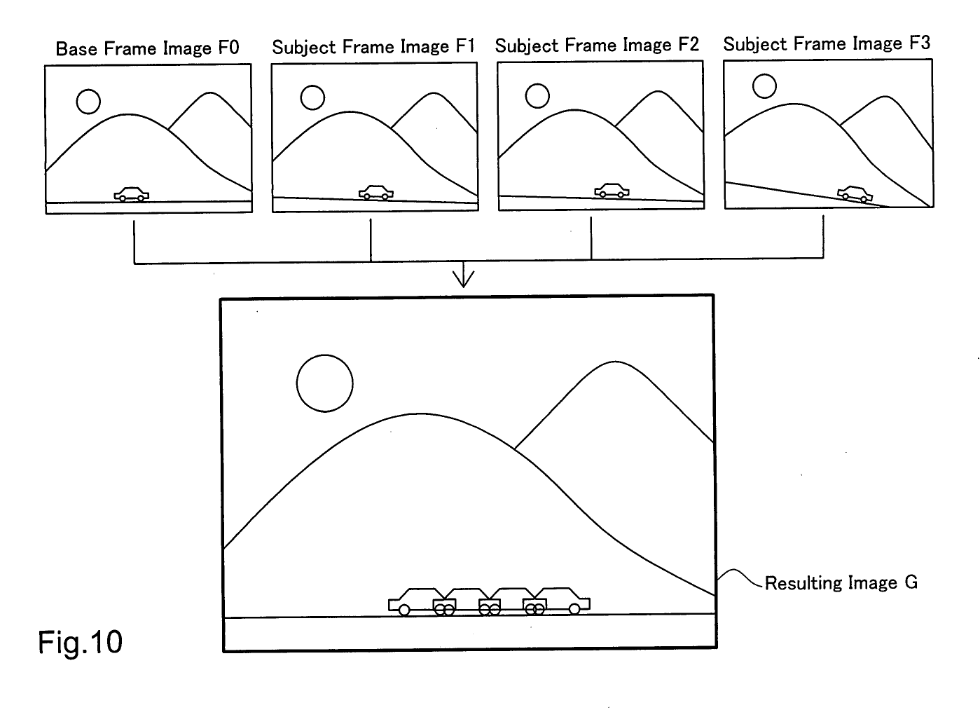

FIG. 10 shows a result of the motion non-follow-up composition in the case of a significant level of motions between multiple frame images. The lower row of the illustration shows a resulting image G obtained by the motion non-follow-up composition of four frame image F0 to F3 on the upper row. The four frame image F0 to F3 on the upper row show a moving picture of an automobile that moves from the left to the right on the screen. Namely the position of the automobile sequentially shifts. The motion non-follow-up composition makes interpolation of each target pixel with pixel data of the selected nearest pixel and pixel data of other surrounding pixels in the frame image including the nearest pixel, whether the selected nearest pixel has a motion or no motion between the frame images. The resulting image G accordingly has a partial image overlap of an identical automobile as shown in FIG. 10.

In this embodiment, the motion non-follow-up composition technique is applied to the resolution enhancement in the case of a low level of motions of the subject frame images relative to the base frame image, where the motion rate Re determined by the motion detection module 108 is not greater than the preset threshold value Rt2(Re≦Rt2).

1-B-4-2. Motion Follow-Up Composition

The motion follow-up composition is executed (step S12 in FIG. 2) in the case of an intermediate level of motions of the subject frame images relative to the base frame image, where the motion rate Re determined by the motion detection module 108 is greater than the preset threshold value Rt2 but is not greater than the preset threshold value Rt1(Rt2<Re≦Rt1). The motion follow-up composition technique enables resolution enhancement without causing a partial image overlap even in the event of a certain level of motions between multiple frame images.

In the process of motion follow-up composition, the shift correction module 106 corrects the subject frame image data with the estimated correction rates obtained in the correction rate estimation process (step S4 in FIG. 2) to eliminate the positional shift of the subject frame image data relative to the base frame image data as shown in FIG. 8 and superposes the corrected subject frame image data on the base frame image data, as in the process of motion non-follow-up composition described above (step S10 in FIG. 2). The resolution enhancement module 110 then detects adjacent pixels of the respective frame images adjoining to each target pixel G(j) included in a resulting still image G and selects a nearest pixel to the target pixel G(j) among the detected adjacent pixels, as in the process of motion non-follow-up composition described above (step S10 in FIG. 2).

The resolution enhancement module 110 subsequently detects a motion or no motion of each nearest pixel relative to the base frame image F0.

When the nearest pixel is included in the base frame image F0, the motion detection is skipped. The resolution enhancement module 110 then generates pixel data of each target pixel G(j) from pixel data of pixels in the base frame image F0 surrounding the target pixel G(j) by any of the diverse interpolation techniques, for example, the bilinear method, the bicubic method, or the nearest neighbor method.

When the nearest pixel is included in one of the subject frame images F1 to F3, on the other hand, the motion detection (FIG. 7) in the motion rate detection process (step S6 in FIG. 2) is executed with replacement of the object pixel Fpt with the nearest pixel. The resolution enhancement module 110 detects a pixel in the base frame image F0 closest to the nearest pixel and replaces the nearby pixel Fp1 of the base frame image Fr in the motion detection of the motion rate detection process described above with the detected pixel of the base frame image F0. The motion detection of the nearest pixel is executed, based on the detected pixel of the base frame image F0 and pixels in the base frame image F0 that adjoin to the detected pixel and surround the nearest pixel.

When the result of the motion detection shows that the nearest pixel has no motion, the resolution enhancement module 110 generates pixel data of each target pixel G(j) from pixel data of the nearest pixel and other pixels in the subject frame image including the nearest pixel, which surround the target pixel G(j), by any of the diverse interpolation techniques, for example, the bilinear method, the bicubic method, or the nearest neighbor method.

When the result of the motion detection shows that the nearest pixel has a motion, on the other hand, the motion detection is carried out in a similar manner with regard to an adjacent pixel second nearest to the target pixel G(j) (hereafter referred to as second nearest pixel) among the detected adjacent pixels. When the result of the motion detection shows that the second nearest pixel has no motion, the resolution enhancement module 110 generates pixel data of each target pixel G(j) from pixel data of the second nearest pixel and other pixels in the subject frame image including the second nearest pixel, which surround the target pixel G(j), by any of the diverse interpolation techniques, for example, the bilinear method, the bicubic method, or the nearest neighbor method.

When the result of the motion detection shows that the second nearest pixel has a motion, on the other hand, the motion detection is carried out in a similar manner with regard to an adjacent pixel third nearest to the target pixel G(j) among the detected adjacent pixels. This series of processing is repeated. In the case of detection of motions in all the adjacent pixels of the respective subject frame images F1 to F3 adjoining to the target pixel G(j), the resolution enhancement module 110 generates pixel data of each target pixel G(j) from pixel data of pixels in the base frame image F0 surrounding the target pixel G(j) by any of the diverse interpolation techniques, for example, the bilinear method, the bicubic method, or the nearest neighbor method.

The resolution enhancement module 110 sequentially sets the target pixel G(j) in the order of j=1, 2, 3 . . . and executes the interpolation described above with regard to all the pixels included in the resulting image G.

As described above, in the motion follow-up process, the resolution enhancement module 110 carries out the motion detection with regard to the detected adjacent pixels of the respective subject frame images in the order of the closeness to the target pixel G(j). In the case of detection of no motion with regard to each object adjacent pixel, the resolution enhancement module 110 generates pixel data of the target pixel G(j) by interpolation with pixel data of the object adjacent pixel with no motion and pixel data of other pixels in the subject frame image including the object adjacent pixel, which surround the target pixel G(j). In the case of detection of motions with regard to all the adjacent pixels in the respective subject frame images adjoining to the target pixel G(j), the resolution enhancement module 110 generates pixel data of the target pixel G(j) by interpolation with pixel data of pixels in the base frame image surrounding the target pixel G(j).

In the case of an intermediate level of motions of the subject frame images F1 to F3 to the base frame image F0, the motion follow-up composition technique excludes the pixels with motion relative to the base frame image F0 from the objects of composition of the four frame images and simultaneous resolution enhancement. The motion follow-up composition technique is thus suitable for an intermediate motion rate between the multiple images.

1-B-4-3. Simple Resolution Enhancement

The simple resolution enhancement is executed (step S14 in FIG. 2) in the case of a significant level of motions of the subject frame images F1 to F3 relative to the base frame image F0, that is, in the case of detection of motions at most positions of the frame images, where the motion rate Re determined by the motion detection module 108 is greater than the preset threshold value Rt1(Re>Rt1).

In the process of simple resolution enhancement, the resolution enhancement module 110 generates pixel data of each target pixel G(j) from pixel data of pixels in the base frame image surrounding the target pixel G(j) by any of the diverse interpolation techniques, for example, the bilinear method, the bicubic method, or the nearest neighbor method, which is adopted in the process of motion non-follow-up composition and in the process of motion follow-up composition.

1-C. Other Motion Rate Detection Methods

As described above, in the motion rate detection process (step S6 in FIG. 2), the motion detection module 108 detects motions of the respective subject frame images F1 to F3 relative to the base frame image F0 and determines their motion rate. The motion rate detection process sets each object pixel Fpt in each subject frame image and determines whether the object pixel Fpt has a luminance value Vtest in the assumed no-motion range. The motion rate detection process detects a motion or no motion of the object pixel Fpt and determines the motion rate, based on the total number of pixels detected as the pixel with motion in the subject frame images.

The motion rate detection method described in the above embodiment may be replaced by any of the following motion rate detection methods 1 through 3 to determine the motion rate.

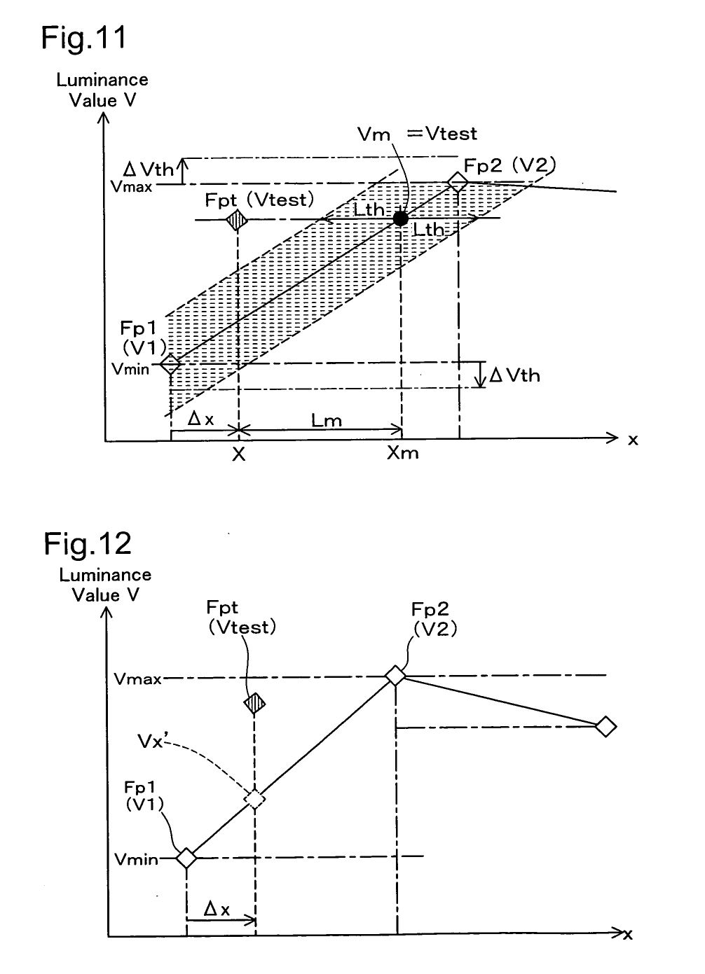

The setting (see FIG. 6) for the motion rate detection process described above is also adopted in the following motion rate detection methods. For the simplicity of explanation with reference to FIGS. 11, 12, and 13, it is assumed that each object pixel Fpt has a one-dimensional position in a lattice defined by four pixels Fp1, Fp2, Fp3, and Fp4 surrounding the object pixel Fpt and is expressed by coordinates (Δx,0) between the two pixels Fp1 and Fp2 aligned in the axis ‘x’.

1-C-1. Motion Rate Detection Method 1

The motion rate detection method 1 is described below. FIG. 11 shows a motion detection process in the motion rate detection method 1. There is generally a high potential of motion when an overall positional shift in the whole image does not match with a local positional shift in part of the image.

By taking into account this fact, the motion detection process assumes a fixed luminance gradient between two pixels Fp1 and Fp2 in a base frame image Fr adjoining to the object pixel Fpt and computes a position Xm of a pixel Fm having a luminance value Vm that is identical with the luminance value Vtest of the object pixel Fpt (hereafter the pixel Fm is referred to as the estimated pixel and the distance Xm is referred to as the estimated distance). A distance between the estimated position Xm and a potentially varying position by the overall positional shift in the whole image is set to a threshold value Lth. Comparison of a distance Lm between the object pixel Fpt and the estimated pixel Fm with the threshold value Lth detects a motion or no motion of the object pixel Fpt.

The motion detection module 108 assumes a fixed luminance gradient between the two pixels Fp1 and Fp2 in the base frame image Fr adjoining to the object pixel Fpt and computes the estimated position Xm having the estimated luminance value Vm that is identical with the luminance value Vtest of the object pixel Fpt. The distance Lm between the position X of the object pixel Fpt and the estimated position Xm of the estimated pixel Fm is given by:
Lm=|Xm−X|=|(Vtest−V1)/(V2−V1)−Δx|

The distance Lm thus calculated is compared with the threshold value Lth. The object pixel Fpt is determined to have a motion when Lm>Lth, while being otherwise determined to have no motion.

In the example described above, the object pixel Fpt is assumed to have the coordinates (Δx,0) relative to the position of the pixel Fp1 in the base frame image Fr as the origin. The description is similarly applied to the object pixel Fpt having the coordinates (0,Δy).

With regard to the object pixel Fpt having the two dimensional coordinates (Δx,Δy), the motion detection process maps the luminance value Vtest onto the object pixel Fpt in both the direction of the ‘x’ axis (lateral direction) and the direction of the ‘y’ axis (vertical direction) relative to the position of the pixel Fp1 in the base frame image Fr as the origin, prior to the motion detection. The motion detection module 108 detects the object pixel Fpt as the pixel with motion in response to a detected motion in at least one of the direction of the ‘x’ axis and the direction of the ‘y’ axis, while otherwise detecting the object pixel Fpt a the pixel with no motion.

The motion detection module 108 detects the motion of each object pixel Fpt in the above manner and repeats this motion detection with regard to all the pixels included in the subject frame image Ft. The sequence of the motion detection may be determined in a similar manner to the motion detection in the motion rate detection process (step S6 in FIG. 2) of the embodiment described above.

On completion of the motion detection with regard to all the pixels included in the subject frame image Ft, the motion detection module 108 counts the number of pixels detected as the pixel with motion in the subject frame image Ft.

The motion detection module 108 counts the number of pixels detected as the pixel with motion in each of the three subject frame images F1 to F3 and sums up the counts to determine a total sum of pixels Sm detected as the pixel with motion in the three subject frame images F1 to F3. The motion detection module 108 also counts the total number of pixels Rj specified as the object pixel of the motion detection in the three subject frame images F1 to F3 and calculates a rate Se(=Sm/Rj) of the total sum of pixels Sm detected as the pixel with motion to the total number of pixels Rj. The rate Se represents a degree of motions in the subject frame images relative to the base frame image and is thus used as the motion rate described previously.

An adequate resolution enhancement process is selected (step S8 in FIG. 2) after the motion rate detection process as described previously. The processing selection module 109 compares the motion rate Se determined by the above motion rate detection method with preset threshold values St1 and St2(1>St1>St2>0) and selects an adequate resolution enhancement process according to the result of the comparison.

The processing selection module 109 first compares the obtained motion rate Se with the preset threshold value St1. When the motion rate Se is greater than the preset threshold value St1(Se>St1), the simple resolution enhancement technique discussed above is selected on the assumption of a significant level of motions in the image. When the motion rate Se is not greater than the preset threshold value St1(Se≦St1), the processing selection module 109 subsequently compares the motion rate Se with the preset threshold value St2. When the motion rate Se is greater than the preset threshold value St2(Se>St2), the motion follow-up composition technique discussed above is selected on the assumption of an intermediate level of motions in the image. When the motion rate Se is not greater than the preset threshold value St2(Se≦St2), the motion non-follow-up composition technique discussed above is selected on the assumption of practically no motions in the image.

1-C-2. Motion Rate Detection Method 2

The motion rate detection method 2 is described below. In the motion rate detection process of the above embodiment (step S6 in FIG. 2), the motion detection module 108 counts the total number of pixels Rj specified as the object pixel of the motion detection and calculates the rate Re(=Rm/Rj) of the total sum of pixels Rm detected as the pixel with motion to the total number of pixels Rj. The motion rate detection method 2 modifies the motion detection process of the embodiment executed by the motion detection module 108. The motion rate detection method 2 computes a motion value of each object pixel Fpt as described below, sums up the motion values of all the pixels to calculate a total sum of the motion values, and determines the motion rate corresponding to the total sum of the motion values. This method is described in detail with reference to FIG. 12.

FIG. 12 shows determination of the motion rate in the motion rate detection method 2.

The motion detection module 108 first computes a maximum Vmax and a minimum Vmin of the luminance values of the two pixels Fp1 and Fp2 in the base frame image Fr adjoining to the object pixel Fpt.

The motion detection module 108 then calculates a luminance value Vx′ of the object pixel Fpt at the position Δx on a line connecting the maximum Vmax with the minimum Vmin of the luminance values. The motion detection module 108 subsequently computes a difference |Vtest−Vx′| as a motion value ΔVk representing a motion of the object pixel Fpt.

The motion detection module 108 computes the motion value ΔVk of each object pixel Fpt in the above manner and repeats this computation of the motion value ΔVk with regard to all the pixels included in the subject frame image Ft. For example, the computation of the motion value may start from a leftmost pixel on an uppermost row in the subject frame image Ft, sequentially run to a rightmost pixel on the uppermost row, and successively run from leftmost pixels to rightmost pixels on respective rows to terminate at a rightmost pixel on a lowermost row. Pixels that are included in the corrected subject frame image Ft partially matched with the base frame image Fr as the result of correction of eliminating the positional shift but are not present on the base frame image Fr should be excluded from the object pixel Fpt of the computation of the motion value.

On completion of computation of the motion values ΔVk with regard to all the pixels included in the subject frame image Ft, the motion detection module 108 sums up the motion values ΔVk of all the pixels in the subject frame image Ft to calculate a sum Vk of the motion values.

The motion detection module 108 calculates the sum Vk of the motion values in each of the three subject frame images F1 to F3 and sums up the calculated sums Vk to a total sum Vkx of the motion values in the three subject frame images F1 to F3. The motion detection module 108 also counts the total number of pixels Rj specified as the object pixel of the motion detection in the three subject frame images F1 to F3 and calculates an average motion value Vav(=Vkx/Rj) of the total number of pixels Rj. The average motion value Vav represents a degree of motions in the subject frame images relative to the base frame image and is thus used as the motion rate described previously.

In the example described above, the object pixel Fpt is assumed to have the coordinates (Δx,0) relative to the position of the pixel Fp1 in the base frame image Fr as the origin. The description is similarly applied to the object pixel Fpt having the coordinates (0,Δy). With regard to the object pixel Fpt having the two dimensional coordinates (Δx,Δy), the motion detection process sets a luminance plane including luminance values V1, V2, and V3, calculates a luminance value Vxy′ of the object pixel Fpt at the position (Δx,Δy) in the luminance plane, computes a difference |Vtest−Vxy′| as the motion value ΔVk representing the motion of the object pixel Fpt, and calculates the average motion value Vav as described above.

An adequate resolution enhancement process is selected (step S8 in FIG. 2) after the motion rate detection process as described previously. The processing selection module 109 compares the motion rate Vav determined by the above motion rate detection method with preset threshold values Vt1 and Vt2(1>Vt1>Vt2>0) and selects an adequate resolution enhancement process according to the result of the comparison.

The processing selection module 109 first compares the obtained motion rate Vav with the preset threshold value Vt1. When the motion rate Vav is greater than the preset threshold value Vt1(Vav>Vt1), the simple resolution enhancement technique discussed above is selected on the assumption of a significant level of motions in the image. When the motion rate Vav is not greater than the preset threshold value Vt1(Vav≦Vt1), the processing selection module 109 subsequently compares the motion rate Vav with the preset threshold value Vt2. When the motion rate Vav is greater than the preset threshold value Vt2(Vav>Vt2), the motion follow-up composition technique discussed above is selected on the assumption of an intermediate level of motions in the image. When the motion rate Vav is not greater than the preset threshold value Vt2(Vav≦Vt2), the motion non-follow-up composition technique discussed above is selected on the assumption of practically no motions in the image.

1-C-3. Motion Rate Detection Method 3

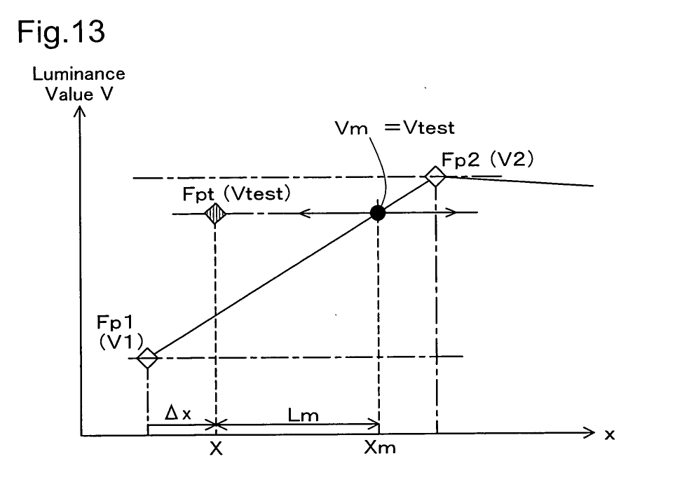

The motion rate detection method 3 is described below. In the motion rate detection method 1 described above, the motion detection module 108 counts the total number of pixels Rj specified as the object pixel of the motion detection and calculates the rate Se(=Sm/Rj) of the total sum of pixels Sm detected as the pixel with motion to the total number of pixels Rj. The motion rate detection method 3 modifies the motion detection process of the motion rate detection method 1 executed by the motion detection module 108. The motion rate detection method 3 computes a motion value of each object pixel Fpt, sums up the motion values of all the pixels to calculate a total sum of the motion values, and determines the motion rate corresponding to the total sum of the motion values. This method is described in detail with reference to FIG. 13.

FIG. 13 shows determination of the motion rate in the motion rate detection method 3.

The motion detection module 108 assumes a fixed luminance gradient between the two pixels Fp1 and Fp2 in the base frame image Fr adjoining to the object pixel Fpt and computes a position Xm of an estimated pixel Fm having an estimated luminance value Vm that is identical with the luminance value Vtest of the object pixel Fpt.

The motion detection module 108 then calculates a distance Lm between the object pixel Fpt and the estimated pixel Fm as a motion value.

The motion detection module 108 computes the motion value Lm of each object pixel Fpt in the above manner and repeats this computation of the motion value Lm with regard to all the pixels included in the subject frame image Ft. For example, the computation of the motion value may start from a leftmost pixel on an uppermost row in the subject frame image Ft, sequentially run to a rightmost pixel on the uppermost row, and successively run from leftmost pixels to rightmost pixels on respective rows to terminate at a rightmost pixel on a lowermost row. Pixels that are included in the corrected subject frame image Ft partially matched with the base frame image Fr as the result of correction of eliminating the positional shift but are not present on the base frame image Fr should be excluded from the object pixel Fpt of the computation of the motion value.

On completion of computation of the motion values Lm with regard to all the pixels included in the subject frame image Ft, the motion detection module 108 sums up the motion values Lm of all the pixels in the subject frame image Ft to calculate a sum Lma of the motion values.

The motion detection module 108 calculates the sum Lma of the motion values in each of the three subject frame images F1 to F3 and sums up the calculated sums Lma to a total sum Lmx of the motion values in the three subject frame images F1 to F3. The motion detection module 108 also counts the total number of pixels Rj specified as the object pixel of the motion detection in the three subject frame images F1 to F3 and calculates an average motion value Lav(=Lmx/Rj) of the total number of pixels Rj. The average motion value Lav represents a degree of motions in the subject frame images relative to the base frame image and is thus used as the motion rate described previously.

In the example described above, the object pixel Fpt is assumed to have the coordinates (Δx,0) relative to the position of the pixel Fp1 in the base frame image Fr as the origin. The description is similarly applied to the object pixel Fpt having the coordinates (0,Δy). With regard to the object pixel Fpt having the two dimensional coordinates (Δx,Δy), the motion detection process maps the luminance value Vtest onto the object pixel Fpt in both the direction of the ‘x’ axis (lateral direction) and the direction of the ‘y’ axis (vertical direction) relative to the position of the pixel Fp1 in the base frame image Fr as the origin, computes motion values in both the direction of the ‘x’ axis and the direction of the ‘y’ axis, sums up the computed motion values to the motion value Lm, and calculates the average motion value Vav as described above.

An adequate resolution enhancement process is selected (step S8 in FIG. 2) after the motion rate detection process as described previously. The processing selection module 109 compares the motion rate Lav determined by the above motion rate detection method with preset threshold values Lt1 and Lt2(1>Lt1>Lt2>0) and selects an adequate resolution enhancement process according to the result of the comparison.

The processing selection module 109 first compares the obtained motion rate Lav with the preset threshold value Lt1. When the motion rate Lav is greater than the preset threshold value Lt1(Lav>Lt1), the simple resolution enhancement technique discussed above is selected on the assumption of a significant level of motions in the image. When the motion rate Lav is not greater than the preset threshold value Lt1(Lav≦Lt1), the processing selection module 109 subsequently compares the motion rate Lav with the preset threshold value Lt2. When the motion rate Lav is greater than the preset threshold value Lt2(Lav>Lt2), the motion follow-up composition technique discussed above is selected on the assumption of an intermediate level of motions in the image. When the motion rate Lav is not greater than the preset threshold value Lt2(Lav≦Lt2), the motion non-follow-up composition technique discussed above is selected on the assumption of practically no motions in the image.

1-D. Effects

As described above, in the selection of the adequate resolution enhancement process (step S8 in FIG. 2), the processing selection module 109 automatically selects the adequate resolution enhancement process among the three available resolution enhancement processes (that is, the motion non-follow-up composition, the motion follow-up composition, and the simple resolution enhancement) according to the motion rate Re determined in the motion rate detection process (step S6 in FIG. 2). This arrangement ensures execution of the adequate resolution enhancement process without the user's selection of a desired resolution enhancement process (among the three available resolution enhancement processes) and thereby generates high-quality still image data.

### 2. Second Embodiment

The procedure of the first embodiment executes the resolution enhancement process immediately after selection of the adequate resolution enhancement process. One modified procedure may give a recommendation of the selected resolution enhancement process to the user. This modified procedure is described below as a second embodiment of the invention with reference to FIGS. 1, 14, and 15.

The still image generation apparatus of the second embodiment has the similar configuration to that of the first embodiment shown in FIG. 1. The computer 100 additionally functions as the recommendation processing module 112.

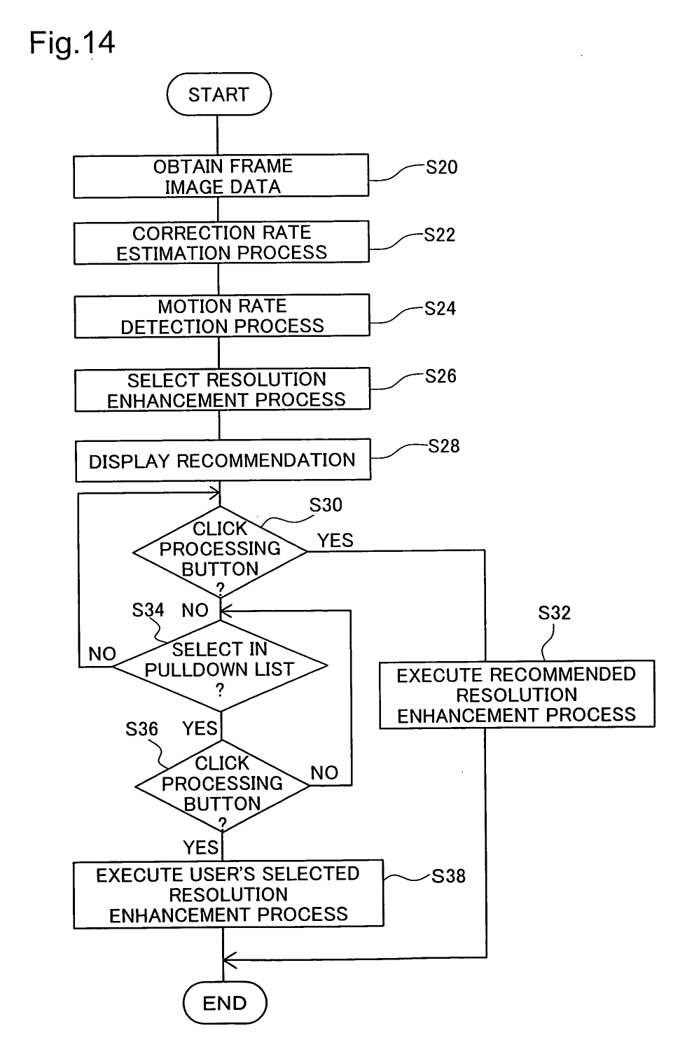

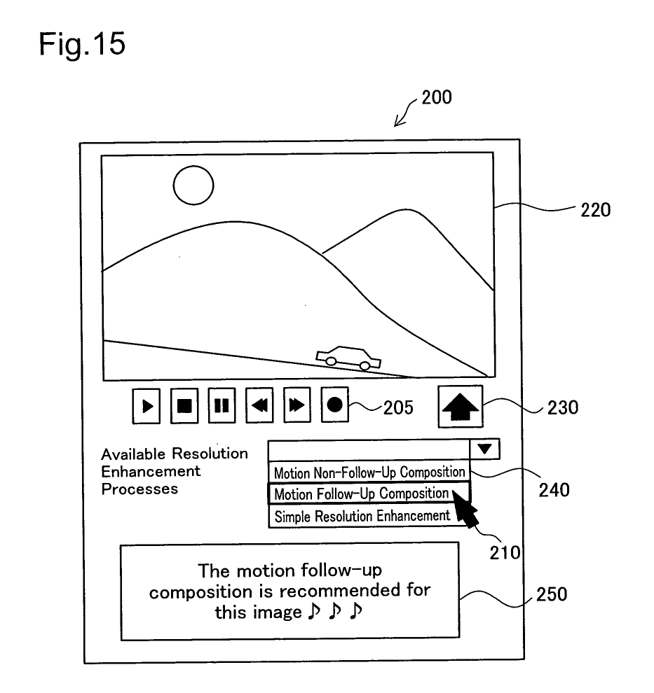

FIG. 14 is a flowchart showing a resolution enhancement process in response to the user's selection. FIG. 15 shows a preview window 200 notifying the user of the recommended resolution enhancement process. The preview window 200 has an upper image display area 220 to reproduce moving pictures and display still images, a middle pulldown list 240 to enable the user to select a desired resolution enhancement process, and a lower recommendation display area 250 to give a recommendation of the resolution enhancement process selected by the processing selection module 109 to the user. A frame image acquisition button 205 and a processing button 230 are provided on the substantial center and the right end of the preview window 200 between the image display area 220 and the pulldown list 240.

In this example, a moving picture is reproduced in the image display area 220 of the preview window 200 open on the display 150. In response to the user's operation of a mouse cursor 210 to click the frame image acquisition button 205, a frame image data acquisition command is entered. The frame image acquisition module 104 accordingly obtains frame image data of multiple consecutive frames in a time series among the moving picture data (step S20) in the same manner as the processing routine of FIG. 2, and freeze-frames the moving picture displayed in the image display area 220. The shift correction module 106 estimates the correction rates of the obtained frame image data (step S22). The shift correction module 106 then superposes the subject frame images corrected with the estimated correction rates on the base frame image. The motion detection module 108 executes the motion rate detection process to determine the motion rate (step S24). The processing selection module 109 selects one resolution enhancement process among the three available resolution enhancement processes according to the determined motion rate (step S26).

The recommendation processing module 112 displays a recommendation of the selected resolution enhancement process to the user in the recommendation display area 250 (step S28) as shown in FIG. 15. In the illustrated example of FIG. 15, the motion follow-up composition is selected as the adequate resolution enhancement process and is recommended to the user with regard to the obtained frame image data.

When selecting execution of the recommended resolution enhancement process, the user operates the mouse cursor 210 to click the processing button 230 (step S30: Yes). The resolution enhancement module 110 then executes the recommended resolution enhancement process displayed in the recommendation display area 250 (step S32).

When not selecting execution of the recommended resolution enhancement process, the user does not immediately click the processing button 230 (step S30: No), but selects a desired resolution enhancement process in the pulldown list 240 (step S34: Yes) and then clicks the processing button 230 (step S36: Yes). The resolution enhancement module 110 then executes the resolution enhancement process selected by the user (step S38).

When the user does not click the processing button 230 (step S30: No) nor select any resolution enhancement process in the pulldown list 240 (step S34: No), the resolution enhancement module 110 waits until the user clicks the processing button 230 or selects a desired resolution enhancement process in the pulldown list 240. The resolution enhancement module 110 also waits until the click of the processing button 230 (step S36: Yes) after the user's selection of a desired resolution enhancement process in the pulldown list 240.

When the user selects one resolution enhancement process in the pulldown list 240 (step S34: Yes) but does not click the processing button 230 (step S36: No), the user is allowed to select another resolution enhancement process different from the first selection in the pulldown list 240. The selection may be the recommended resolution enhancement process.

In the structure of the second embodiment, the display in the recommendation display area 250 notifies the user of recommendation of the resolution enhancement process selected by the still image generation apparatus. The user is allowed to freely select a desired resolution enhancement process with referring to the recommendation.

### 3. Third Embodiment

The procedure of the first embodiment determines the motion rate in the frame images in the units of pixels. One modified procedure may divide each frame image into multiple blocks and detect the motion rate in the units of blocks. This modified procedure is described below as a third embodiment of the invention.

The still image generation apparatus of the third embodiment basically has the similar configuration to that of the first embodiment shown in FIG. 1. The still image generation process to the correction rate estimation (step S4 in FIG. 2) executed by the motion detection module 108 in the third embodiment is identical with the processing flow of the first embodiment shown in FIG. 2 and is thus not specifically described here.

3-A. Still Image Generation Process

In the structure of this embodiment, the shift correction module 106 executes correction with the estimated correction rates to eliminate the positional shifts of the subject frame images F1 to F3 relative to the base frame image F0. The resolution enhancement module 110 executes one of three available resolution enhancement processes discussed later to generate still image data. The suitability of any of the three resolution enhancement processes depends upon the rate of ‘motions’ in the frame images. As mentioned previously, the user has difficulties in selecting an adequate process among the three available resolution enhancement processes for each image.

The procedure of this embodiment detects motions in multiple divisional blocks of the respective frame images, determines a rate of motions (motion rate) in the frame images based on the detected motions in the respective blocks, and selects an adequate process among the three available resolution enhancement processes according to the detected motion rate. The following describes the motion rate detection process executed in this embodiment. The three available resolution enhancement processes selectively executed according to the result of the motion rate detection process will be discussed later.

3-A-1. Motion Rate Detection Process

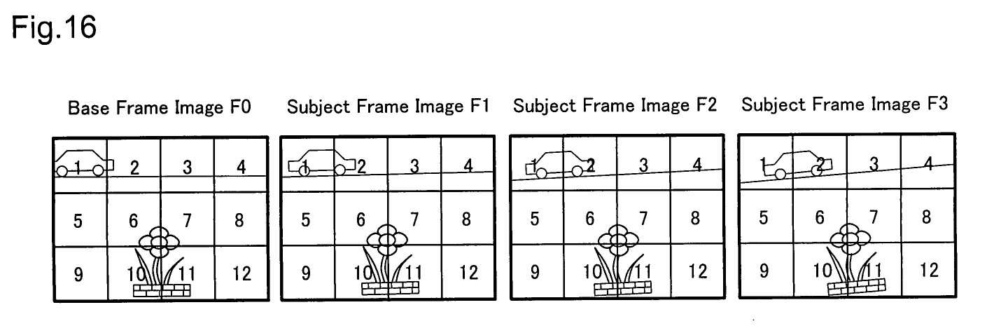

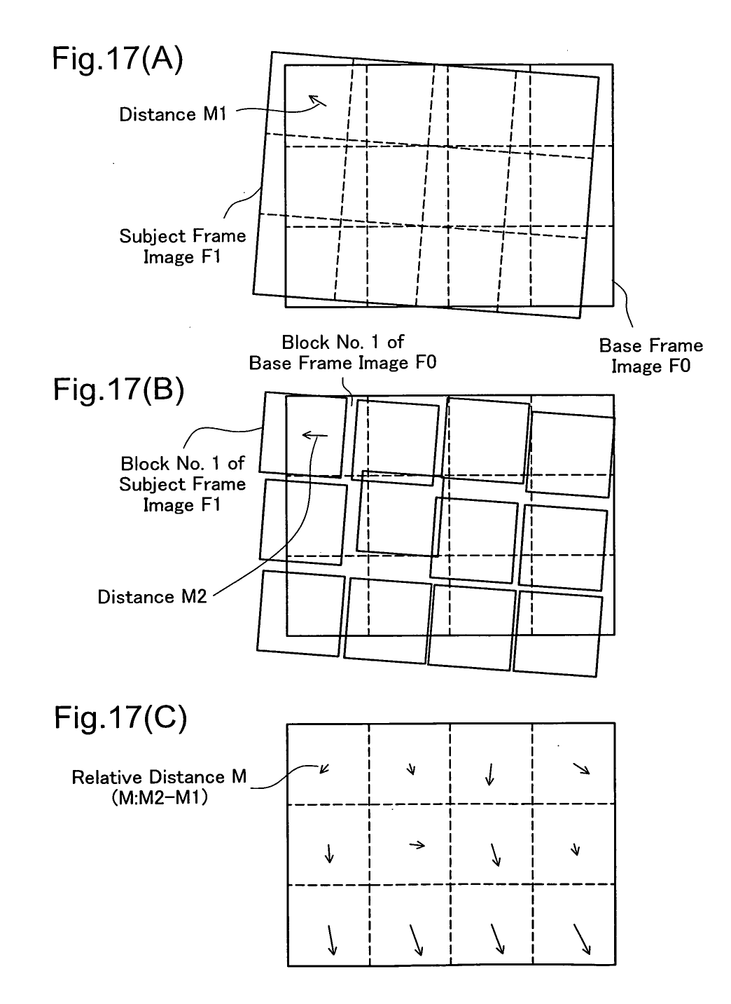

On completion of the correction rate estimation process (step S4 in FIG. 2), a motion rate detection process is executed (step S6 in FIG. 2). The outline of the motion rate detection process is described with reference to FIGS. 16 and 17.

FIG. 16 shows a base frame image and subject frame images respectively divided into 12 blocks in the third embodiment of the invention. As shown in FIG. 16, the base frame image F0 is divided into 12 blocks, while each of the subject frame images F1 to F3 is also divided into 12 blocks. Numerals 1 to 12 are allocated to the 12 blocks of each frame image sequentially from an upper left block to a lower right block.

In the units of the whole images, there are positional shifts between the respective subject frame images F1 to F3 and the base frame image F0 as described previously with regard to the correction rate estimation process. In the units of blocks, however, the respective blocks have different degrees of positional shifts including a zero shift between the base frame image F0 and the subject frame image F1 to F3.

FIGS. 17(A), (B), and (C) show the outline of the motion rate detection process executed in the third embodiment of the invention. The illustration of FIG. 17 shows only the positional relation between the base frame image F0 and the subject frame image F1 with omission of the pictures thereon.

FIG. 17(A) shows a distance M1 used to eliminate the positional shift of the subject frame image F1 relative to the base frame image F0 in the unit of the whole image as described previously with regard to the correction rate estimation process. The distance M1 is computed from the correction rates u1, v1, and δ1, which are estimated in the correction rate estimation process (step S4 in FIG. 2) to eliminate the positional shifts of the subject frame images F1 to F3 relative to the base frame image F0 in the units of the whole images.

FIG. 17(B) shows distances M2 used to eliminate the various degrees of the positional shifts of the subject frame image F1 relative to the base frame image F0 in the respective blocks. Computation of the distances M2 is discussed later.

FIG. 17(C) shows relative distances M, that is, the distances M2 relative to the distance M1.

The relative distance M is described briefly.

There may be an ‘overall displacement’ between frame images of moving picture data, for example, by blurring of the images due to hand movement. The distance M1 is used to eliminate this ‘overall displacement’ of the whole image. There may also be a ‘local motion’ between the frame images of the moving picture data, which may arise simultaneously with the ‘overall displacement’. The distances M2 are used to eliminate the ‘overall displacement’ and the ‘local motion’ in the units of blocks.

The difference between the distance M1 for correcting the overall positional shift of the whole image (that is, the positional shift based on the ‘overall displacement’ of the whole image by blurring of the images due to hand movement) and the distance M2 for correcting the positional shift in each block (that is, the positional shift based on the ‘local motion’ arising simultaneously with the ‘overall displacement’) gives the relative distance M, which represents the ‘local motion’ with cancellation of the ‘overall displacement’ of the whole image.

The motion rate detection process (step S6 in FIG. 2) first estimates correction rates ub1, vb1, and δb1 for elimination of the positional shifts of the respective blocks in each of the subject frame images F1 to F3 relative to the corresponding blocks in the base frame image F0 as shown in FIG. 17(B), and calculates distances M2 in the respective blocks from the estimated correction rates ub1, vb1, and δb1. The motion rate detection process then calculates the relative distance M (FIG. 17(C)) from the distance M2 (FIG. 17(B)) and the distance M1 (FIG. 17(A)) in each block, and detects a motion or no motion in each block according to the calculated relative distance M. The motion rate is determined by counting the number of the blocks detected as the block with motions. In this embodiment, both the distances M1 and M2 represent moving lengths from the center of each block in the base frame image. The respective blocks of the subject frame images F1 to F3 have substantially identical shapes and dimensions with those of the corresponding blocks of the base frame image F0.

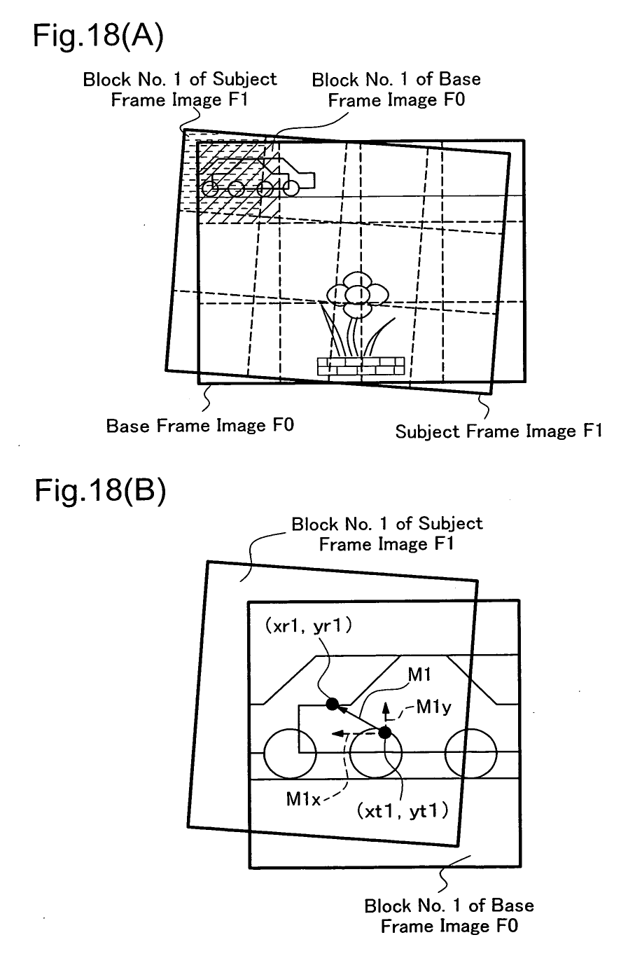

The motion rate detection process is described below in detail with reference to FIGS. 18, 19, and 20. The illustration of FIGS. 18, 19, and 20 regard the positional relation between the subject frame image F1 and the base frame image F0, like the illustration of FIG. 17.

FIGS. 18(A) and 18(B) show computation of distances used for correction in a block with a numeral ‘1’ or a block No. 1 of the subject frame image F1. FIG. 18(A) shows a result of correction with the estimated correction rates obtained in the correction rate estimation process (step S4 in FIG. 2) to eliminate an overall positional shift of the subject frame image F1 relative to the base frame image F0. In the illustration of FIG. 18(A), the block No. 1 of the base frame image F0 is hatched, while the corresponding block No. 1 of the subject frame image F1 is screened. FIG. 18(B) is an enlarged view of the hatched block and the screened block of FIG. 18(A), that is, the block No. 1 of the base frame image F0 and the block No. 1 of the corrected subject frame image F1 after correction with the estimated correction rates u1, v1, and δ1 to eliminate the overall positional shift of the subject frame image F1 relative to the base frame image F0. The illustration of FIG. 18(B) includes center coordinates (xt1, yt1) in the block No. 1 of the subject frame image F1 on the base frame image prior to correction of eliminating the overall positional shift of the whole image, and coordinates (xr1, yr1) on the base frame image moved from the center coordinates (xt1, yt1) by the correction of eliminating the overall positional shift of the whole image.

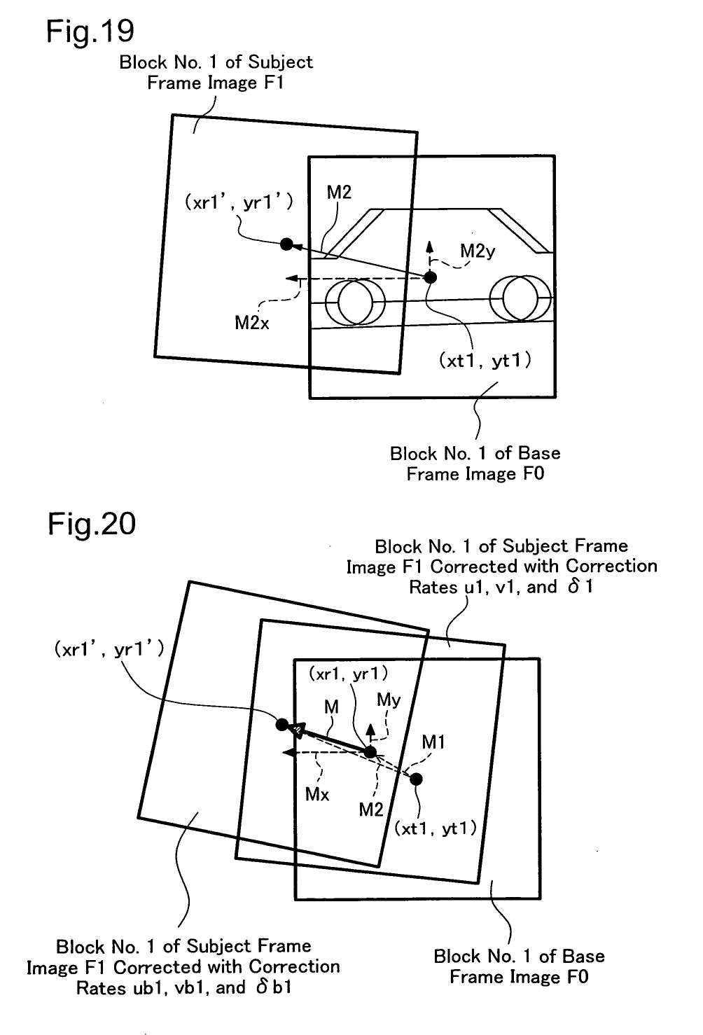

FIG. 19 is an enlarged view showing the block No. 1 of the corrected subject frame image F1 after correction with estimated correction rates ub1, vb1, and δb1 to eliminate a positional shift of the block No. 1 of the subject frame image F1 relative to the corresponding block No. 1 of the base frame image F0. The illustration of FIG. 19 includes the center coordinates (xt1, yt1) in the block No. 1 of the subject frame image F1 on the base frame image prior to correction of eliminating the positional shift in the block No. 1, and coordinates (xr1′, yr1′) on the base frame image moved from the center coordinates (xt1, yt1) by the correction of eliminating the positional shift in the block No. 1.

The center coordinates (xt1, yt1) in the block No. 1 of the subject frame image F1 on the base frame image prior to correction of eliminating the overall positional shift of the whole image shown in FIG. 18(B) is naturally identical with the center coordinates (xt1, yt1) in the block No. 1 of the subject frame image F1 on the base frame image prior to correction of eliminating the positional shift in the block No. 1 shown in FIG. 19.

FIG. 20 shows computation of the relative distance M in the block No. 1 of the subject frame image F1 relative to the block No. 1 of the base frame image F0. More specifically, the illustration of FIG. 20 is superposition of the illustration of FIG. 19 on the illustration of FIG. 18(B) with the fixed position of the block No. 1 of the base frame image F0.

The shift correction module 106 reads the correction rates u1, v1, and δ1, which are estimated by the correction rate estimation process (step S4 in FIG. 2) described above to eliminate the overall positional shift of the whole image, from a memory (not shown), and executes correction with the correction rates u1, v1, and δ1 to eliminate the overall positional shift of the subject frame image F1 relative to the base frame image F0 as shown in FIG. 18(A). The shift correction module 106 calculates the center coordinates (xr1, yr1) in the block No. 1 of the subject frame image F1 on the base frame image (see FIG. 18(B)), which are moved by the correction of eliminating the overall positional shift of the whole image, from the center coordinates (xt1, yt1) in the block No. 1 of the subject frame image F1 prior to the correction (see FIG. 18(B)) and the estimation correction rates u1, v1, and δ1 according to Equations given below:
xr1=cos δ1·(xt1+u1)−sin δ1·(yt1+v1) (1)
yr1=sin δ1·(xt1+u1)+cos δ1·(yt1+v1) (2)

The motion detection module 108 calculates a lateral component M1x and a vertical component M1y of a distance M1 in the block No. 1 of the subject frame image F1 relative to the corresponding block No. 1 of the base frame image F0 (that is, a distance M1 used for correction of eliminating the overall positional shift of the whole image) shown in FIG. 18(B) according to Equations given below with the above Equations (1) and (2):
M1x=xr1−xt1 (3)
M1y=yr1−yt1 (4)

The shift correction module 106 computes the correction rates ub1, vb1, and δb1 of eliminating the positional shift of the block No. 1 of the subject frame image F1 relative to the corresponding block No. 1 of the base frame image F0 as estimated values from pixel data of the block No. 1 of the base frame image F0 and pixel data of the block No. 1 of the subject frame image F1 by the method adopted in the correction rate estimation process (step S4 in FIG. 2) described above, that is, according to the preset calculation formulae of the pattern matching method, the gradient method, or the least-squares method. Here ub1, vb1, and δb1 respectively denote the correction rate for eliminating a translational shift in the lateral direction, a translational shift in the vertical direction, and a rotational shift.

The shift correction module 106 executes correction with the estimated correction rates ub1, vb1, and δb1 to eliminate the positional shift of the block No.1 of the subject frame image F1 relative to the corresponding block No. 1 of the base frame image F0 as shown in FIG. 19. The shift correction module 106 calculates the center coordinates (xr1′, yr1′) in the block No. 1 of the subject frame image F1 on the base frame image (see FIG. 19), which are moved by the correction of eliminating the positional shift in each block, from the center coordinates (xt1, yt1) in the block No. 1 of the subject frame image F1 prior to the correction (see FIG. 19) and the estimation correction rates ub1, vb1, and δb1 according to Equations given below:
xr1′=cos δb1·(xt1+ub1)−sin δb1·(yt1+vb1) (5)
yr1′=sin δb1·(xt1+ub1)+cos δb1·(yt1+vb1) (6)

The motion detection module 108 calculates a lateral component M2x and a vertical component M2y of a distance M2 in the block No. 1 of the subject frame image F1 relative to the corresponding block No. 1 of the base frame image F0 (that is, a distance M2 used for correction of eliminating the positional shift in each block) shown in FIG. 19 according to Equations given below with the above Equations (5) and (6):
M2x=xr1′−xt1 (7)
M2y=yr1′−yt1 (8)

The motion detection module 108 calculates a lateral component Mx and a vertical component My of a relative distance M, that is, the distance M2 relative to the distance M1 (see FIG. 20) according to Equations given below with the above Equations (3), (4), (7), and (8):
Mx=M2x−M1x(=xr1′−xr1) (9)
My=M2y−M1y(=yr1′−yr1) (10)

The motion detection module 108 then calculates the magnitude |M| of the relative distance M according to Equation given below with the above Equations (9) and (10): |M|=((Mx)²+(My)²)^{1/2} (11)

The motion detection module 108 compares the magnitude |M| of the relative distance M calculated according to the above Equation (11) with a preset threshold value mt. The block No.1 of the subject frame image F1 under the condition of |M|≧mt is detected as a block with motions, whereas the block No.1 of the subject frame image F1 under the condition of |M|<mt is detected as a block with no motion.

The motion detection module 108 detects the motion of the block No. 1 of the subject frame image F1 in the above manner and repeats this motion detection with regard to all the blocks included in the subject frame image F1. For example, the motion detection may be executed sequentially from the block No.1 to the block No. 12 of the subject frame image F1.

On completion of the motion detection with regard to all the blocks included in the subject frame image F1, the motion detection module 108 counts the number of blocks detected as the block with motions in the subject frame image F1.

The motion detection module 108 counts the number of blocks detected as the block with motions in each of the three subject frame images F1 to F3 and sums up the counts to determine a total sum of blocks Mc detected as the block with motions in the three subject frame images F1 to F3. The motion detection module 108 also counts a total number of blocks Mb specified as the object of the motion detection in the three subject frame images F1 to F3 and calculates a rate Me(=Mc/Mb) of the total sum of blocks Mc detected as the block with motions to the total number of blocks Mb. The rate Me represents a degree of motions in the subject frame images relative to the base frame image and is thus used as the motion rate described previously.

3-A-2. Selection of Resolution Enhancement Process

On completion of the motion rate detection process (step S6 in FIG. 2), an adequate resolution enhancement process is selected (step S8 in FIG. 2).

The procedure of this embodiment compares the motion rate Me obtained in the motion detection process (step S6 in FIG. 2) with preset threshold values Mt1 and Mt2(1>Mt1>Mt2>0) and selects an adequate resolution enhancement process according to the result of the comparison.

The processing selection module 109 first compares the obtained motion rate Me with the preset threshold value Mt1. When the motion rate Me is greater than the preset threshold value Mt1(Me>Mt1), simple resolution enhancement (discussed later) is selected on the assumption of a significant level of motions in the image. When the motion rate Me is not greater than the preset threshold value Mt1(Me≦Mt1), the processing selection module 109 subsequently compares the motion rate Me with the preset threshold value Mt2. When the motion rate Me is greater than the preset threshold value Mt2(Me>Mt2), motion follow-up composition (discussed later) is selected on the assumption of an intermediate level of motions in the image. When the motion rate Me is not greater than the preset threshold value Mt2(Me≦Mt2), motion non-follow-up composition (discussed later) is selected on the assumption of practically no motions in the image.

In one example, it is assumed that the preset threshold values Mt1 and Mt2 are respectively set equal to 0.8 and to 0.2. When the motion rate Me is greater than 0.8, the simple resolution enhancement technique is selected. When the motion rate Me is greater than 0.2 but is not greater than 0.8, the motion follow-up composition technique is selected. When the motion rate Me is not greater than 0.2, the motion non-follow-up composition technique is selected.

2-A-3. Resolution Enhancement Process

After selection of the adequate resolution enhancement process (step S8 in FIG. 2), the selected resolution enhancement process is executed (steps S10 to S14 in FIG. 2).

The resolution enhancement module 110 executes the adequate resolution enhancement process selected among the three available resolution enhancement processes (that is, motion non-follow-up composition, motion follow-up composition, and simple resolution enhancement) by the processing selection module 109.

3-A-3-1. Motion Non-Follow-Up Composition

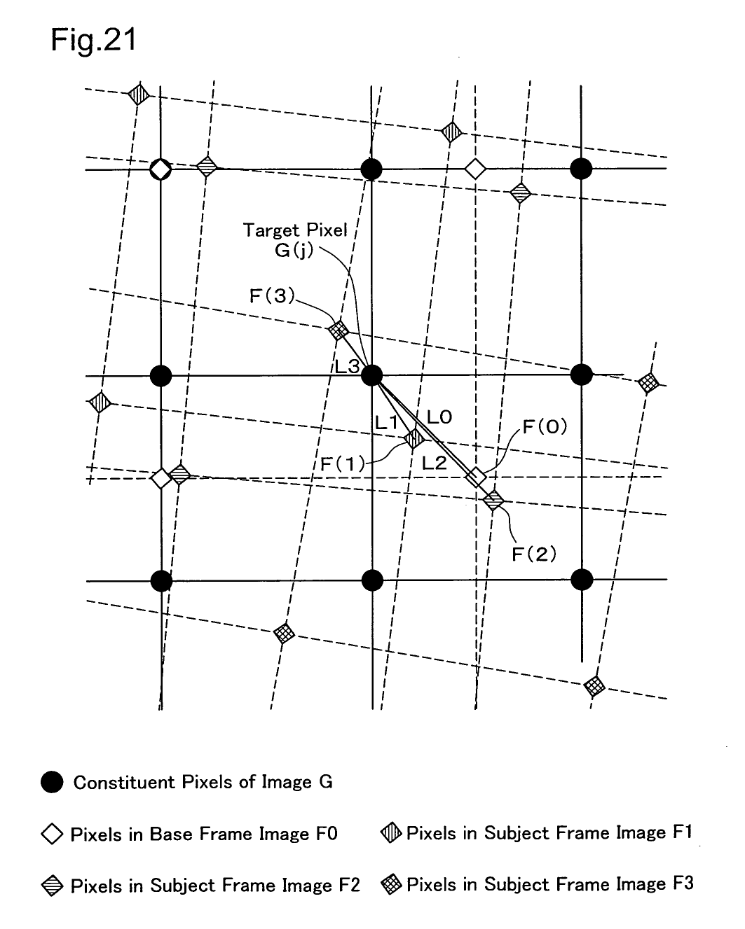

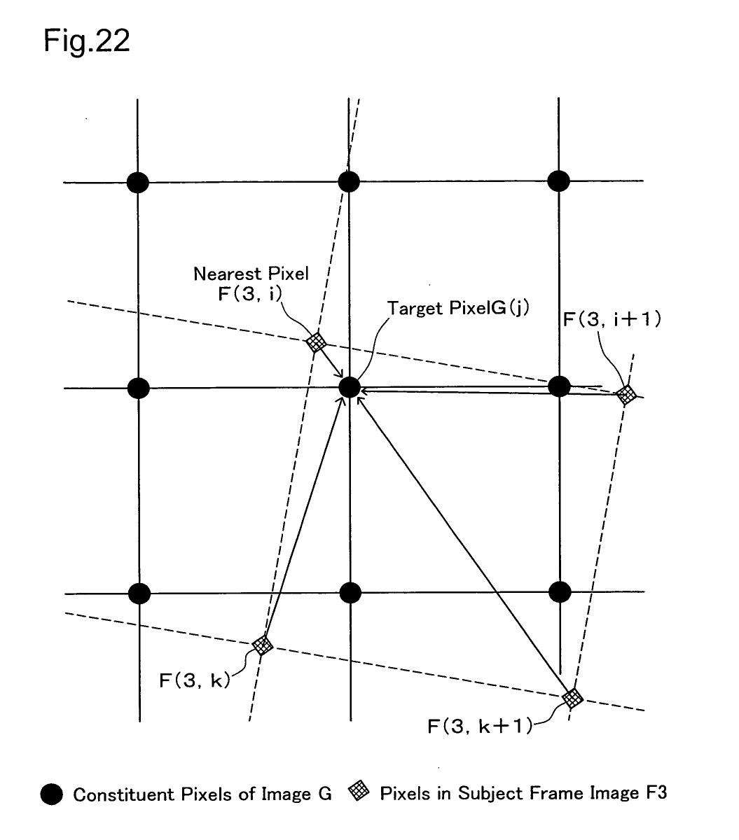

The process of motion non-follow-up composition (step S10 in FIG. 2) is described first. In the process of motion non-follow-up composition, the shift correction module 106 corrects the subject frame image data with the estimated correction rates obtained in the correction rate estimation process (step S4 in FIG. 2) to eliminate the positional shift of the subject frame image data relative to the base frame image data. The resolution enhancement module 110 then enhances the resolution simultaneously with superposition of the corrected subject frame image data on the base frame image data to generate still image data. The resolution enhancement module 110 applies a preset interpolation to pixels that are not in the base frame image nor in the subject frame images among pixels constituting a resulting still image (hereafter referred to as ‘constituent pixels’). The preset interpolation uses pixel data representing pixel values of surrounding pixels that are present in the vicinity of the constituent pixels (that is, tone data representing tone values) and attains enhancement of the resolution simultaneously with composition of the subject frame images with the base frame image. The motion non-follow-up composition is described briefly with reference to FIGS. 21 and 22.

FIG. 21 shows superposition of the corrected subject frame images F1 to F3 on the base frame image F0 after elimination of the positional shift. In the illustration of FIG. 21, closed circles, open boxes, and hatched boxes respectively represent constituent pixels of a resulting image G, pixels included in the base frame image F0, and pixels included in the corrected subject frame images F1 to F3. In this illustrated example, the pixel density of the resulting image G is increased to 1.5 times in both length and width relative to the pixel density of the base frame image F0. The constituent pixels of the resulting image G are positioned to overlap the pixels of the base frame image F0 at intervals of every two pixel positions. The positions of the constituent pixels of the resulting image G are, however, not restricted to those overlapping the pixels of the base frame image F0 but may be determined according to various requirements. For example, all the pixels of the resulting image G may be located in the middle of the respective pixels of the base frame image F0. The rate of the resolution enhancement is not restricted to 1.5 times in length and width but may be set arbitrarily according to the requirements.

The following description mainly regards a certain pixel G(j) included in the resulting image G. A variable ‘j’ gives numbers allocated to differentiate all the pixels included in the resulting image G. For example, the number allocation may start from a leftmost pixel on an uppermost row in the resulting image G, sequentially go to a rightmost pixel on the uppermost row, and successively go from leftmost pixels to rightmost pixels on respective rows to terminate at a rightmost pixel on a lowermost row. The resolution enhancement module 110 selects a pixel having the shortest distance (hereafter referred to as ‘nearest pixel’) to the certain pixel G(j) (hereafter referred to as ‘target pixel G(j)’).

The resolution enhancement module 110 detects neighbor pixels (adjacent pixels) F(0), F(1), F(2), and F(3) of the respective frame images F0, F1, F2, and F3 adjoining to the target pixel G(j), computes distances L0, L2, L2, and L3 between the detected adjacent pixels F(0), F(1), F(2), and F(3) and the target pixel G(j), and determines the nearest pixel. In the illustrated example of FIG. 21, L3<L1<L0<L2. The resolution enhancement module 110 thus selects the pixel F(3) of the subject frame image F3 as the nearest pixel to the target pixel G(j). The nearest pixel to the target pixel G(j) is hereafter expressed as F(3,i), which means the i-th pixel in the subject frame image F3.

The resolution enhancement module 110 repeatedly executes this series of processing with regard to all the constituent pixels included in the resulting image G in the order of the numbers of the target pixel G(j), where j=1, 2, 3, . . . to select nearest pixels to all the constituent pixels.

The resolution enhancement module 110 then generates pixel data of each target pixel G(j) from pixel data of the selected nearest pixel and pixel data of other pixels in the frame image including the selected nearest pixel, which surround the target pixel G(j), by any of the diverse interpolation techniques, for example, the bilinear method, the bicubic method, or the nearest neighbor method. The interpolation by the bilinear method is described below.

FIG. 22 shows interpolation by the bilinear method. The target pixel G(j) is not present in any of the base frame image F0 and the corrected subject frame images F1 to F3 after elimination of the positional shift. The target pixel G(j) accordingly has no pixel data. In response to selection of the adjacent pixel F(3) of the subject frame image F3 as the nearest pixel F(3,i) to the target pixel G(j), the resolution enhancement module 110 draws a virtual area defined by three other pixels F(3,i+1), F(3,k), F(3,k+1) in the subject frame image F3 surrounding the target pixel G(j), as well as the nearest pixel F(3,i) as shown in FIG. 22. The resolution enhancement module 110 then divides the virtual area into four divisions by the target pixel G(j), multiplies the pixel data at the respective diagonal positions by preset weights corresponding to the area ratio, and sums up the weighted pixel data to interpolate the pixel data of the target pixel G(j). Here k represents a number allocated to a pixel that is adjacent to the i-th pixel in the lateral direction of the subject frame image F3.

As described above, the motion non-follow-up composition makes interpolation of each target pixel with pixel data of surrounding pixels in a frame image including a selected nearest pixel, among the base frame image and the subject frame images. This technique ensures resolution enhancement simultaneously with composition and gives a significantly high-quality still image.

The motion non-follow-up composition technique is especially suitable for a very low motion rate of the subject frame images relative to the base frame image.

This is because the motion non-follow-up composition may cause a problem discussed below in the presence of significant motions of the subject frame images relative to the base frame image.

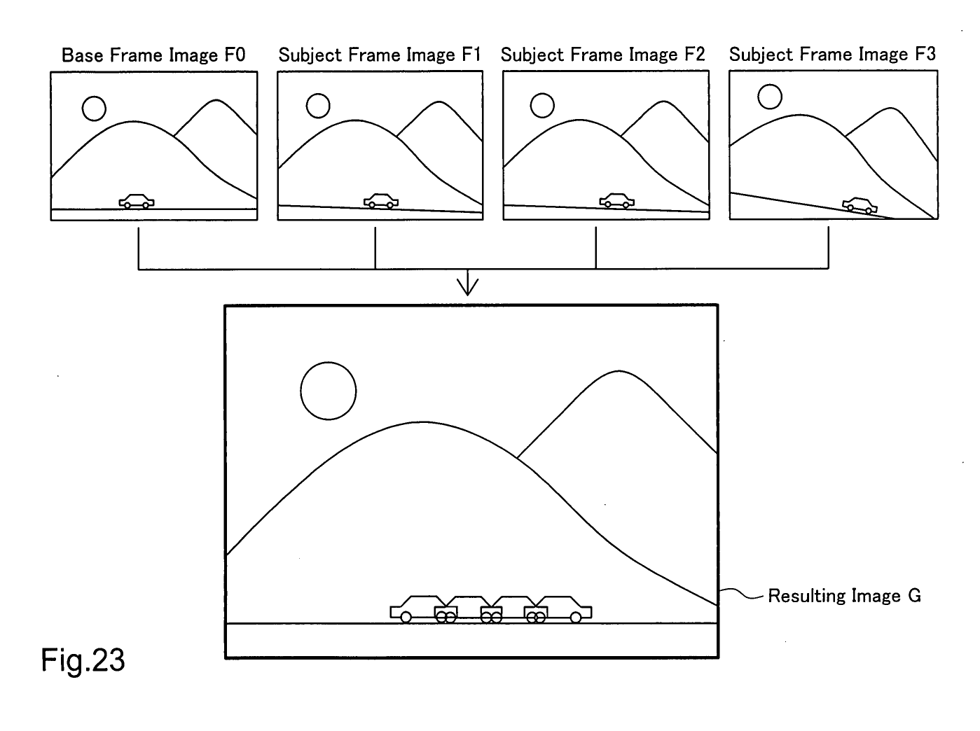

FIG. 23 shows a result of the motion non-follow-up composition in the case of a significant level of motions between multiple frame images. The lower row of the illustration shows a resulting image G obtained by the motion non-follow-up composition of four frame image F0 to F3 on the upper row. The four frame image F0 to F3 on the upper row show a moving picture of an automobile that moves from the left to the right on the screen. Namely the position of the automobile sequentially shifts. The motion non-follow-up composition makes interpolation of each target pixel with pixel data of the selected nearest pixel and pixel data of other surrounding pixels in the frame image including the nearest pixel, whether the selected nearest pixel has a motion or no motion between the frame images. The resulting image G accordingly has a partial image overlap of an identical automobile as shown in FIG. 23.

In this embodiment, the motion non-follow-up composition technique is applied to the resolution enhancement in the case of a low level of motions of the subject frame images relative to the base frame image, where the motion rate Me determined by the motion detection module 108 is not greater than the preset threshold value Mt2(Me≦Mt2).

3-A-3-2. Motion Follow-Up Composition

The motion follow-up composition is executed (step S12 in FIG. 2) in the case of an intermediate level of motions of the subject frame images relative to the base frame image, where the motion rate Me determined by the motion detection module 108 is greater than the preset threshold value Mt2 but is not greater than the preset threshold value Mt1(Mt2<Me≦Mt1). The motion follow-up composition technique enables resolution enhancement without causing a partial image overlap even in the event of a certain level of motions between multiple frame images.

In the process of motion follow-up composition, the shift correction module 106 corrects the subject frame image data with the estimated correction rates obtained in the correction rate estimation process (step S4 in FIG. 2) to eliminate the positional shift of the subject frame image data relative to the base frame image data as shown in FIG. 21 and superposes the corrected subject frame image data on the base frame image data, as in the process of motion non-follow-up composition described above (step S10 in FIG. 2). The resolution enhancement module 110 then detects adjacent pixels of the respective frame images adjoining to each target pixel G(j) included in a resulting still image G and selects a nearest pixel to the target pixel G(j) among the detected adjacent pixels, as in the process of motion non-follow-up composition described above (step S10 in FIG. 2).

The resolution enhancement module 110 subsequently detects a motion or no motion of each nearest pixel relative to the base frame image F0 as described below.

In the following simplified explanation of the motion rate detection process, Fr and Ft respectively denote a base frame image and a subject frame image. Each pixel as an object of the motion detection is referred to as an object pixel.

The resolution enhancement module 110 specifies an object pixel and detects a nearby pixel in the base frame image Fr closest to the specified object pixel. The resolution enhancement module 110 then detects a motion or no motion of the specified object pixel, based on the detected nearby pixel in the base frame image Fr and adjacent pixels in the base frame image Fr that adjoin to the detected nearby pixel and surround the object pixel. The method of motion detection is described below.

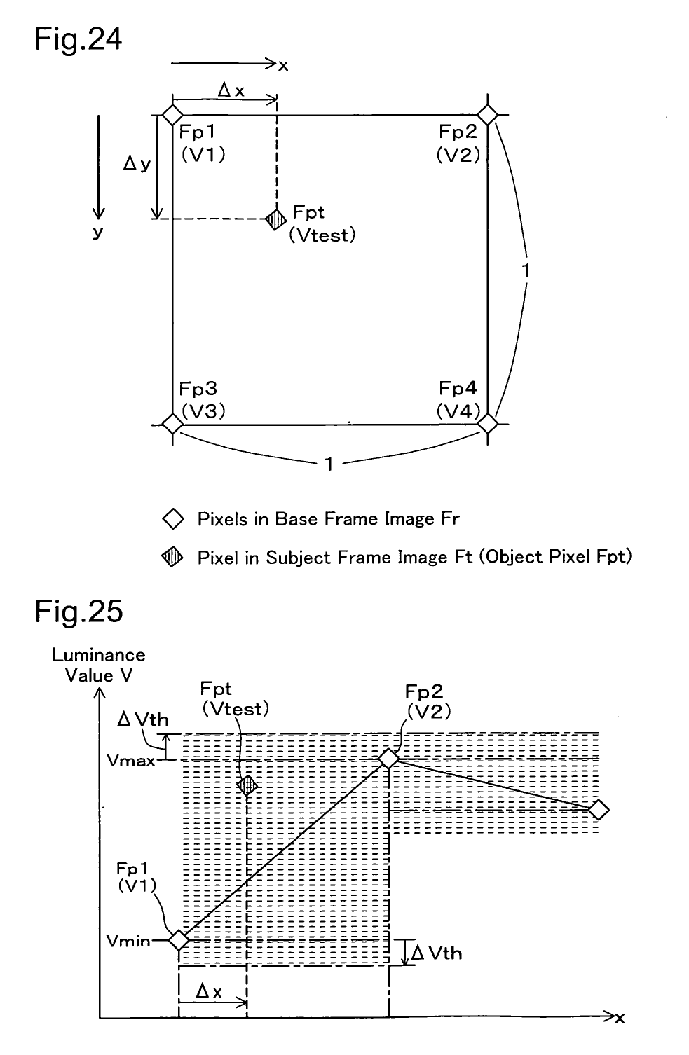

FIG. 24 shows setting for description of the motion detection method executed in the third embodiment of the invention. One hatched box in FIG. 24 represents the object pixel Fpt included in the subject frame image Ft. Four open boxes arranged in a lattice represent four pixels Fp1, Fp2, Fp3, and Fp4 in the base frame image Fr to surround the object pixel Fpt. In this illustrated example, the pixel Fp1 is closest to the object pixel Fpt. The object pixel Fpt has a luminance value Vtest, and the four pixels Fp1, Fp2, Fp3, and Fp4 respectively have luminance values V1, V2, V3, and V4. A position (Δx,Δy) in the lattice defined by the four pixels Fp1, Fp2, Fp3, and Fp4 is expressed by coordinates in a lateral axis ‘x’ and in a vertical axis ‘y’ in a value range of 0 to 1 relative to the position of the upper left pixel Fp1 as the origin.

For the simplicity of explanation with reference to FIG. 25, it is assumed that the object pixel Fpt has a one-dimensional position in the lattice and is expressed by coordinates (Δx,0) between the two pixels Fp1 and Fp2 aligned in the axis ‘x’.

FIG. 25 shows the motion detection method adopted in the third embodiment of the invention. The object pixel Fpt in the subject frame image Ft is expected to have an intermediate luminance value between the luminance values of the adjoining pixels Fp1 and Fp2 in the base frame image Fr, unless there is a spatially abrupt change in luminance value. Based on such expectation, a range between a maximum and a minimum of the luminance values of the adjoining pixels Fp1 and Fp2 close to the object pixel Fpt is assumed as a no-motion range. In order to prevent a noise-induced misdetection, the assumed no-motion range may be extended by the width of a threshold value ΔVth. The motion detection module 108 determines the presence or the absence of the luminance value Vtest of the object pixel Fpt in the assumed no-motion range and thereby detects a motion or no motion of the object pixel Fpt.

The motion detection module 108 first computes a maximum Vmax and a minimum Vmin of the luminance values of the two pixels Fp1 and Fp2 in the base frame image Fr adjoining to the object pixel Fpt according to equations given below:
Vmax=max(V1,V2)
Vmin=min(V1,V2)
where max( ) and min( ) respectively represent a function of determining a maximum among the elements in the brackets and a function of determining a minimum among the elements in the brackets.

The object pixel Fpt is detected as a pixel with motion when the luminance value Vtest of the object pixel Fpt satisfies the following two relational expressions, while otherwise being detected as a pixel with no motion:

Vtest>Vmin−ΔVth
Vtest<Vmax+ΔVth

In the description below, the assumed no-motion range is also referred to as the target range. In this example, a range of Vmin−ΔVth<V<Vmax+ΔVth between the adjoining pixels to the object pixel Fpt is the target range.

In the example described above, the object pixel Fpt is assumed to have the coordinates (Δx,0) relative to the position of the pixel Fp1 in the base frame image Fr as the origin. The description is similarly applied to the object pixel Fpt having the coordinates (0,Δy). With regard to the object pixel Fpt having the two dimensional coordinates (Δx,Δy), the maximum Vmax and the minimum Vmin of the luminance values are given by:
Vmax=max(V1,V2,V3,V4)
Vmin=min(V1,V2,V3,V4)

The resolution enhancement module 110 detects a motion or no motion of each nearest pixel according to the motion detection method discussed above. When the nearest pixel is included in the base frame image F0, the motion detection is skipped. The resolution enhancement module 110 then generates pixel data of each target pixel G(j) from pixel data of pixels in the base frame image F0 surrounding the target pixel G(j) by any of the diverse interpolation techniques, for example, the bilinear method, the bicubic method, or the nearest neighbor method.

When the result of the motion detection shows that the nearest pixel has no motion, the resolution enhancement module 110 generates pixel data of each target pixel G(j) from pixel data of the nearest pixel and other pixels in the subject frame image including the nearest pixel, which surround the target pixel G(j), by any of the diverse interpolation techniques, for example, the bilinear method, the bicubic method, or the nearest neighbor method.

When the result of the motion detection shows that the nearest pixel has a motion, on the other hand, the motion detection is carried out in a similar manner with regard to an adjacent pixel second nearest to the target pixel G(j) (hereafter referred to as second nearest pixel) among the detected adjacent pixels. When the result of the motion detection shows that the second nearest pixel has no motion, the resolution enhancement module 110 generates pixel data of each target pixel G(j) from pixel data of the second nearest pixel and other pixels in the subject frame image including the second nearest pixel, which surround the target pixel G(j), by any of the diverse interpolation techniques, for example, the bilinear method, the bicubic method, or the nearest neighbor method.

When the result of the motion detection shows that the second nearest pixel has a motion, on the other hand, the motion detection is carried out in a similar manner with regard to an adjacent pixel third nearest to the target pixel G(j) among the detected adjacent pixels. This series of processing is repeated. In the case of detection of motions in all the adjacent pixels of the respective subject frame images F1 to F3 adjoining to the target pixel G(j), the resolution enhancement module 110 generates pixel data of each target pixel G(j) from pixel data of pixels in the base frame image F0 surrounding the target pixel G(j) by any of the diverse interpolation techniques, for example, the bilinear method, the bicubic method, or the nearest neighbor method.

The resolution enhancement module 110 sequentially sets the target pixel G(j) in the order of j=1, 2, 3 . . . and executes the interpolation described above with regard to all the pixels included in the resulting image G.

As described above, in the motion follow-up process, the resolution enhancement module 110 carries out the motion detection with regard to the detected adjacent pixels of the respective subject frame images in the order of the closeness to the target pixel G(j). In the case of detection of no motion with regard to each object adjacent pixel, the resolution enhancement module 110 generates pixel data of the target pixel G(j) by interpolation with pixel data of the object adjacent pixel with no motion and pixel data of other pixels in the subject frame image including the object adjacent pixel, which surround the target pixel G(j). In the case of detection of motions with regard to all the adjacent pixels in the respective subject frame images adjoining to the target pixel G(j), the resolution enhancement module 110 generates pixel data of the target pixel G(j) by interpolation with pixel data of pixels in the base frame image F0 surrounding the target pixel G(j).

In the case of an intermediate level of motions of the subject frame images F1 to F3 to the base frame image F0, the motion follow-up composition technique excludes the pixels with motion relative to the base frame image F0 from the objects of composition of the four frame images and simultaneous resolution enhancement. The motion follow-up composition technique is thus suitable for an intermediate motion rate between the multiple images.

3-A-3-3. Simple Resolution Enhancement

The simple resolution enhancement is executed (step S14 in FIG. 2) in the case of a significant level of motions of the subject frame images F1 to F3 relative to the base frame image F0, that is, in the case of detection of motions at most positions of the frame images, where the motion rate Me determined by the motion detection module 108 is greater than the preset threshold value Mt1(Me>Mt1).

In the process of simple resolution enhancement, the resolution enhancement module 110 generates pixel data of each target pixel G(j) from pixel data of pixels in the base frame image surrounding the target pixel G(j) by any of the diverse interpolation techniques, for example, the bilinear method, the bicubic method, or the nearest neighbor method, which is adopted in the process of motion non-follow-up composition and in the process of motion follow-up composition.

3-B. Effects

As described above, in the selection of the adequate resolution enhancement process (step S8 in FIG. 2), the processing selection module 109 automatically selects the adequate resolution enhancement process among the three available resolution enhancement processes (that is, the motion non-follow-up composition, the motion follow-up composition, and the simple resolution enhancement) according to the motion rate Me determined in the motion rate detection process (step S6 in FIG. 2). This arrangement ensures execution of the adequate resolution enhancement process without the user's selection of a desired resolution enhancement process among the three available resolution enhancement processes and thereby generates high-quality still image data.

In the motion rate detection process (step S6 in FIG. 2), the motion detection module 108 detects a motion or no motion of each block in each of the subject frame images F1 to F3 relative to the base frame image F0, counts the number of blocks detected as the block with motions, and determines the motion rate of the whole subject frame images F1 to F3 relative to the base frame image F0. The procedure of this embodiment detects the motion in the larger units of blocks, instead of detecting the motion in the units of pixels, and determines the total sum of the detected motions as the motion rate. This arrangement desirably shortens the total processing time.

### 4. Fourth Embodiment

A fourth embodiment of the invention is described briefly. Like the third embodiment, the still image generation apparatus of the fourth embodiment basically has the similar configuration to that of the first embodiment shown in FIG. 1. The still image generation process to the correction rate estimation (step S4 in FIG. 2) executed by the motion detection module 108 in the fourth embodiment is identical with the processing flow of the first embodiment shown in FIG. 2 and is thus not specifically described here.

There is, however, some difference between the still image generation apparatus of the fourth embodiment and the still image generation apparatus of the third embodiment. The still image generation apparatus of the third embodiment selects an adequate resolution enhancement process for a whole image and executes the selected resolution enhancement process with regard to pixels included in the whole image. The still image generation apparatus of the fourth embodiment, on the other hand, selects an adequate resolution enhancement process for each block of an image and executes the selected resolution enhancement process with regard to pixels included in the block.

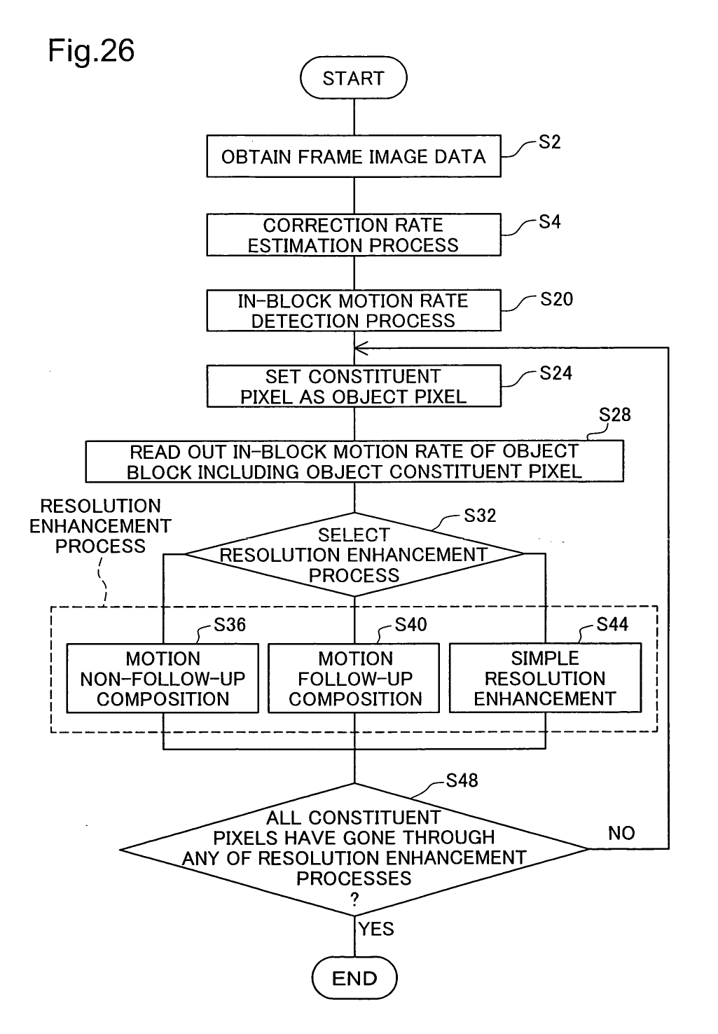

In the motion rate detection process (step S6 in FIG. 2) executed in the still image generation apparatus of the third embodiment, the processing selection module 109 selects one among the three available resolution enhancement processes (that is, motion non-follow-up composition, motion follow-up composition, and simple resolution enhancement) according to the motion rate Re of the subject frame images F1 to F3 relative to the base frame image. The resolution enhancement module 110 executes the selected resolution enhancement process with regard to all the pixels included in a resulting image. In the still image generation apparatus of the fourth embodiment, on the other hand, the processing selection module 109 selects one among the three available resolution enhancement processes in each block according to an in-block motion rate of each block in the subject frame images F1 to F3 as discussed below. The resolution enhancement module 110 executes the selected resolution enhancement process with regard to pixels included in each block. The procedure of this embodiment is described with regard to corresponding blocks with a numeral ‘1’ in the subject frame images F1 to F3 with referring to FIG. 26.

FIG. 26 is a flowchart showing a still image data generation process executed in the fourth embodiment of the invention.

On completion of the correction rate estimation process (step S4 in FIG. 26), an in-block motion rate detection process (step S20 in FIG. 26) is executed. In the in-block motion rate detection process, the motion detection module 108 first calculates the magnitude |M| of the relative distance in each block of the subject frame images F1 to F3 relative to the base frame image in the same manner as the motion rate detection process of the third embodiment (step S6 in FIG. 2) described above. The motion detection module 108 then sums up the relative distances M of the corresponding blocks with an identical numeral in the respective subject frame images F1 to F3 and divides the sum of the relative distances M by the number of the corresponding blocks with an identical numeral (3 since there are three subject frame images F1 to F3 in this illustrated example) to calculate an average BM(=M/3) of the relative distance M. The average relative distance BM represents a degree of motions in corresponding blocks with an identical number of the respective subject frame images F1 to F3 relative to a corresponding block with the identical number of the base frame image and is thus used as the in-block motion rate in the block described above. The computed in-block motion rate BM is stored in a predetermined area of a memory (not shown).

On completion of the in-block motion rate detection process, constituent pixels are successively set as an object pixel of the processing (step S24 in FIG. 26). The resolution enhancement module 110 sets a certain constituent pixel as an object pixel in a resulting still image. For example, setting of the constituent pixels may start from a leftmost constituent pixel on an uppermost row in a resulting still image, sequentially go to a rightmost constituent pixel on the uppermost row, and successively go from leftmost constituent pixels to rightmost constituent pixels on respective rows to terminate at a rightmost constituent pixel on a lowermost row.

The in-block motion rate BM is then read out with regard to each object block including each constituent pixel set as the object pixel (step S28 in FIG. 26). The resolution enhancement module 110 reads out the in-block motion rate BM of the object block including the object constituent pixel, from the predetermined area of the memory (not shown).

After reading the in-block motion rate BM of the object block including the object constituent pixel, one adequate resolution enhancement process is selected (step S32 in FIG. 26). In selection of the resolution enhancement process, the processing selection module 109 first compares the obtained in-block motion rate BM with preset threshold values Bmt1 and Bmt2(1>Bmt1>Bmt2>0). When the in-block motion rate BM is greater than the preset threshold value Bmt1(BM>Bmt1), the processing selection module 109 selects the simple resolution enhancement for the object block on the assumption of a significant level of motions in the object block including the object constituent pixel. When the in-block motion rate BM is not greater than the preset threshold value Bmt1(BM≦Bmt1), the processing selection module 109 subsequently compares the in-block motion rate BM with the preset threshold value Bmt2. When the in-block motion rate BM is greater than the preset threshold value Bmt2(BM>Bmt2), the processing selection module 109 selects the motion follow-up composition for the object block on the assumption of an intermediate level of motions in the object block including the object constituent pixel. When the in-block motion rate BM is not greater than the preset threshold value Bmt2(BM≦Bmt2), the processing selection module 109 selects the motion non-follow-up composition for the object block on the assumption of practically no motions in the object block including the object constituent pixel.

In one example, it is assumed that the preset threshold values Bmt1 and Bmt2 are respectively set equal to 0.8 and to 0.2. When the in-block motion rate BM is greater than 0.8, the simple resolution enhancement technique is selected for the object block including the object constituent pixel. When the in-block motion rate BM is greater than 0.2 but is not greater than 0.8, the motion follow-up composition technique is selected for the object block including the object constituent pixel. When the in-block motion rate BM is not greater than 0.2, the motion non-follow-up composition technique is selected for the object block including the object constituent pixel.

In the case where the adequate resolution enhancement process has already been selected for one object block including a constituent pixel set as an object pixel, another selection is not required for the same object block. The processing selection module 109 may thus skip the selection.

After selection of the adequate resolution enhancement process, the selected resolution enhancement process is executed (steps S36 to S44 in FIG. 26) for the constituent pixels included in the object block.

The resolution enhancement module 110 executes the adequate resolution enhancement process selected among the three available resolution enhancement processes (that is, the motion non-follow-up composition, the motion follow-up composition, and the simple resolution enhancement) with regard to the constituent pixels included in the object block.

On completion of the selected resolution enhancement process (steps S36 to S44 in FIG. 26), it is determined that all the constituent pixels in the resulting still image have gone through any of the three available resolution enhancement processes (step S48). In the case where there is any constituent pixel in the resulting still image that has not yet gone through any of the resolution enhancement processes (step S48: No), the resolution enhancement module 110 goes back to step S24 to set a next constituent pixel as an object pixel of the processing. In the case where all the constituent pixels in the resulting still image have gone through any of the resolution enhancement processes (step S48: Yes), on the other hand, the resolution enhancement module 110 concludes generation of the still image data.

As described above, the procedure of this embodiment selects one optimum resolution enhancement process among the three available resolution enhancement processes according to the in-block motion rate of each object block including a certain constituent pixel set as an object pixel of the processing, and executes the selected resolution enhancement process for the constituent pixels included in each object block. In the case where an image has localized motions, an adequate resolution enhancement process is automatically selected and executed in a portion with localized motions, while another adequate resolution enhancement process is automatically selected and executed in a residual portion with little motions. This arrangement thus ensures generation of the high-quality still image data.

### 5. Fifth Embodiment

A fifth embodiment of the invention is described briefly. Like the third and the fourth embodiments, the still image generation apparatus of the fifth embodiment basically has the similar configuration to that of the first embodiment shown in FIG. 1. The still image generation process to the correction rate estimation (step S4 in FIG. 2) executed by the motion detection module 108 in the fifth embodiment is identical with the processing flow of the first embodiment shown in FIG. 2 and is thus not specifically described here.

The difference between the still image generation apparatus of this embodiment and the still image generation apparatus of the third embodiment is the method of computing the motion rate. In the still image generation apparatus of the third embodiment, the motion detection module 108 compares the calculated relative distance in each block of the subject frame images F1 to F3 with the preset threshold value mt to detect the motions in the block, and computes the motion rate Me from the total sum of blocks Mc detected as the block with motions. In the still image generation apparatus of this embodiment, on the other hand, the motion detection module 108 sums up the calculated relative distances in the respective blocks of the subject frame images F1 to F3 to compute a motion rate Mg.

The processing selection module 109 compares the motion rate Mg with preset threshold values Mt3 and Mt4 and selects an adequate resolution enhancement process according to the result of the comparison. The processing selection module 109 first compares the obtained motion rate Mg with the preset threshold value Mt3. When the motion rate Mg is greater than the preset threshold value Mt3(Mg>Mt3), the simple resolution enhancement is selected on the assumption of a significant level of motions in the image. When the motion rate Mg is not greater than the preset threshold value Mt3(Mg≦Mt3), the processing selection module 109 subsequently compares the motion rate Mg with the preset threshold value Mt4. When the motion rate Mg is greater than the preset threshold value Mt4(Mg>Mt4), the motion follow-up composition is selected on the assumption of an intermediate level of motions in the image. When the motion rate Mg is not greater than the preset threshold value Mt4(Mg≦Mt4), the motion non-follow-up composition is selected on the assumption of practically no motions in the image.

As described above, the procedure of this embodiment does not sum up the number of blocks detected as the block with motions on the basis of the calculated relative distances in the respective blocks of the subject frame images F1 to F3, so as to compute the motion rate. The procedure of this embodiment, however, simply sums up the calculated relative distances in the respective blocks of the subject frame images F1 to F3 to compute the motion rate. This arrangement of the embodiment desirably shortens the processing time required for computation of the motion rate.

### 6. Sixth Embodiment

A sixth embodiment of the invention is described briefly. Like the third through the fifth embodiments, the still image generation apparatus of the sixth embodiment basically has the similar configuration to that of the first embodiment shown in FIG. 1. The still image generation process to the correction rate estimation (step S4 in FIG. 2) executed by the motion detection module 108 in the sixth embodiment is identical with the processing flow of the first embodiment shown in FIG. 2 and is thus not specifically described here.

The difference between the still image generation apparatus of this embodiment and the still image generation apparatus of the third embodiment is the method of detecting motions in the respective blocks of the subject frame images F1 to F3. In the still image generation apparatus of the third embodiment, the motion detection module 108 calculates the relative distances in the respective blocks of the subject frame images F1 to F3, detects the motions in the respective blocks on the basis of the calculated relative distances, and computes the motion rate Me. In the still image generation apparatus of this embodiment, on the other hand, the motion detection module 108 detects the motion in each pixel included in each block of the subject frame images F1 to F3, computes an in-block motion rate in the block from the total number of pixels detected as the pixel with motion, and detects the motion or no motion of each block based on the computed in-block motion rate. The procedure of this embodiment is described with regard to corresponding blocks with the numeral ‘1’ or the blocks No. 1 in the base frame image F0 and the subject frame image F1.

The motion detection module 108 adopts the motion detection method (see FIG. 25) of the motion follow-up composition technique (step S12 in FIG. 2) described above to detect the motion in each pixel included in the block No. 1 of the subject frame image F1. The object pixel Fpt in the motion detection method (FIG. 25) of the motion follow-up composition technique is replaced by a target pixel of the motion detection (hereafter expressed as the target pixel Z). The motion detection module 108 detects a pixel in the base frame image F0 closest to the target pixel Z, replaces the nearby pixel Fp1 in the base frame image Fr in the motion detection method of the motion follow-up composition technique with the detected closest pixel in the base frame image F0, and detects the motion or no motion of the target pixel Z based on the detected closest pixel in the base frame image F0 and adjacent pixels in the base frame image F0 that adjoin to the detected closest pixel and surround the target pixel Z.

On completion of the motion detection with regard to all the pixels included in the block No. 1 of the subject frame image F1, the motion detection module 108 determines a total sum of pixels Hc detected as the pixel with motion in the block No. 1 of the subject frame image F1. The motion detection module 108 also counts a total number of pixels Hb specified as the target pixel of the motion detection in the block No. 1 of the subject frame image F1, and calculates a rate He(=Hc/Hb) of the total sum of pixels Hc detected as the pixel with motion to the total number of pixels Hb. The rate He represents a degree of motions in the block No. 1 of the subject frame image F1 relative to the block No. 1 of the base frame image and is thus used as the in-block motion rate described above. The motion detection module 108 compares the absolute value of the computed in-block motion rate He in the block No. 1 of the subject frame image F1 with a preset threshold value ht. Under the condition of |He|≧ht, the block No. 1 of the subject frame image F1 is detected as the block with motions. Under the condition of |He|<ht, on the other hand, the block No. 1 of the subject frame image F1 is detected as the block with no motions.

The motion detection module 108 detects the motions in the respective blocks of the subject frame images F1 to F3 in the same manner as the motion detection with regard to the block No. 1 of the subject frame image F1 described above.

As described above, the procedure of this embodiment sums up the number of pixels detected as the pixel with motion in each block of the subject frame images F1 to F3 and detects the motion or no motion of the block based on the total sum of pixels detected as the pixel with motion. This arrangement of the embodiment enables motions of even subtle elements (motions in the units of pixels) to be well reflected on the motion detection of each block, thus ensuring highly precise motion detection.

### 7. Seventh Embodiment

A seventh embodiment of the invention is described briefly. Like the third through the sixth embodiments, the still image generation apparatus of the seventh embodiment basically has the similar configuration to that of the first embodiment shown in FIG. 1. The still image generation process to the correction rate estimation (step S4 in FIG. 2) executed by the motion detection module 108 in the seventh embodiment is identical with the processing flow of the first embodiment shown in FIG. 2 and is thus not specifically described here.

The difference between the still image generation apparatus of this embodiment and the still image generation apparatus of the third embodiment is also the method of detecting motions in the respective blocks of the subject frame images F1 to F3. In the still image generation apparatus of the third embodiment, the motion detection module 108 calculates the relative distances in the respective blocks of the subject frame images F1 to F3, detects the motions in the respective blocks on the basis of the calculated relative distances, and computes the motion rate Me. In the still image generation apparatus of this embodiment, on the other hand, the motion detection module 108 computes a motion value of each pixel included in each block of the subject frame images F1 to F3 as described below, calculates an in-block motion rate in the block from a total sum of the computed motion values, and detects the motion or no motion in the block based on the calculated in-block motion rate. The procedure of this embodiment is described with regard to corresponding blocks with the numeral ‘1’ or the blocks No. 1 in the base frame image F0 and the subject frame image F1.

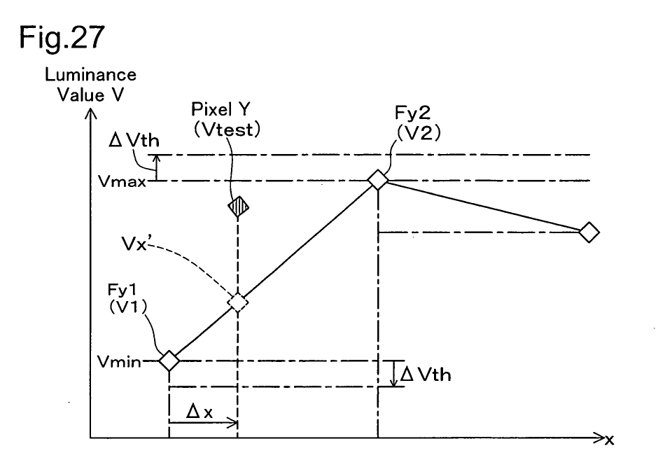

FIG. 27 shows computation of a motion value in the block No. 1 of the subject frame image F1 executed in the seventh embodiment of the invention.

The motion detection module 108 computes a motion value of each pixel included in the block No. 1 of the subject frame image F1 under the conditions of the motion detection method (FIG. 25) of the motion follow-up composition technique (step S12 in FIG. 2). The object pixel Fpt in the motion detection method (FIG. 25) of the motion follow-up composition technique is replaced by a target pixel of the motion value computation (hereafter expressed as the target pixel Y). The motion detection module 108 detects a pixel (Fy1) in the base frame image F0 closest to the target pixel Y, replaces the nearby pixel Fp1 in the base frame image Fr in the motion detection method of the motion follow-up composition technique with the detected closest pixel Fy1 in the base frame image F0, and computes a motion rate based on the detected closest pixel Fy1 in the base frame image F0 and an adjacent pixel Fy2 in the base frame image F0 that adjoins to the closest pixel Fy1 and surrounds the target pixel Y.

The motion detection module 108 first computes a maximum Vmax and a minimum Vmin of the luminance values of the two pixels Fy1 and Fy2 in the base frame image F0 adjoining to the target pixel Y.

The motion detection module 108 then calculates a luminance value Vx′ of the target pixel Y at a position Δx on a line connecting the maximum Vmax with the minimum Vmin of the luminance values. The motion detection module 108 subsequently computes a difference |Vtest−Vx′| as a motion value ΔVk representing a motion of the target pixel Y.

The motion detection module 108 computes the motion value ΔVk of each target pixel Y in the above manner and repeats this computation of the motion value ΔVk with regard to all the pixels included in the block No. 1 of the subject frame image F1.

On completion of computation of the motion values ΔVk with regard to all the pixels included in the block No. 1 of the subject frame image F1, the motion detection module 108 sums up the motion values AVk of all the pixels included in the block No. 1 of the subject frame image F1 to calculate a sum Vk of the motion values.

The motion detection module 108 also counts the total number of pixels Vb specified as the target pixel of the motion detection in the block No. 1 of the subject frame image F1 and calculates an average motion value Vav (=Vk/Vb) of the total number of pixels Vb in the block No. 1 of the subject frame image F1. The average motion value Vav represents a degree of motions in the block No. 1 of the subject frame image 1 relative to the block No. 1 of the base frame image and is thus used as the in-block motion rate described previously.

The motion detection module 108 compares the absolute value of the obtained in-block motion rate Vav in the block No. 1 of the subject frame image F1 with a preset threshold value vt. Under the condition of |Vav|≧vt, the block No. 1 of the subject frame image F1 is detected as the block with motions. Under the condition of |Vav|<vt, on the other hand, the block No. 1 of the subject frame image F1 is detected as the block with no motions.

The motion detection module 108 detects the motions in the respective blocks of the subject frame images F1 to F3 in the same manner as the motion detection with regard to the block No. 1 of the subject frame image F1 described above.

As described above, the procedure of this embodiment calculates the sum of motion values of the respective pixels included in each block of the subject frame images F1 to F3 and detects the motion or no motion of the block based on the calculated sum of motion values. This arrangement of the embodiment enables even local motions (motions in the units of pixels) to be well reflected on the motion detection of each block, thus ensuring highly precise motion detection.

### 8. Modifications

The embodiments and their modified examples discussed above are to be considered in all aspects as illustrative and not restrictive. There may be many other modifications, changes, and alterations without departing from the scope or spirit of the main characteristics of the present invention.

In the embodiments discussed above, the resolution enhancement module 110 is capable of executing any of the three available resolution enhancement processes. The number of the available resolution enhancement processes is, however, not limited to 3 but may be only 1 or 2 or may be 4 or greater. The processing selection module 109 selects one among any number of available resolution enhancement processes executable by the resolution enhancement module 110.

In the embodiments discussed above, the procedure selects and executes one resolution enhancement process among the three available resolution enhancement processes (that is, the motion follow-up composition, the motion non-follow-up composition, and the simple resolution enhancement). The technique of the invention is, however, not restricted to this procedure. One modified procedure selects, for example, the motion follow-up composition as the resolution enhancement process and changes over the details of the motion follow-up composition technique according to the determined motion rate. Namely the motion follow-up composition technique selectively executes a series of processing corresponding to the motion non-follow-up composition and a series of processing corresponding to the simple resolution enhancement, as well as a series of processing corresponding to the original motion follow-up composition. This modified procedure is described below as a modified example of the first embodiment. The processing of steps S2 through S6 in FIG. 2 in this modified example is identical with that in the first embodiment and is thus not specifically described here.

The description first regards the processing flow of the motion follow-up composition technique corresponding to the motion non-follow-up composition. When the motion rate Re determined by the motion detection module 108 is not greater than the preset threshold value Rt2(Re≦Rt2) in the selection of the resolution enhancement process (step S8 in FIG. 2), an infinite width is set to the object range of the motion detection in the motion follow-up composition with regard to the respective pixels included in each subject frame image. Such setting causes all the pixels included in each subject frame image to be detected as the pixel with no motion. In the processing flow of the motion follow-up composition technique, the resolution enhancement module 110 accordingly generates pixel data of each target pixel G(j) from pixel data of a nearest pixel and pixel data of other pixels in a subject frame image including the nearest pixel, which surround the target pixel G(j), by any of diverse interpolation techniques, for example, the bilinear method, the bicubic method, or the nearest neighbor method. The processing flow of the motion follow-up composition technique thus gives the practically equivalent processing result to that of the motion non-follow-up composition.

The description then regards the processing flow of the motion follow-up composition technique corresponding to the simple resolution enhancement. When the motion rate Re determined by the motion detection module 108 is greater than the preset threshold value Rt1(Re>Rt1) in the selection of the resolution enhancement process (step S8 in FIG. 2), a zero width is set to the object range of the motion detection in the motion follow-up composition with regard to the respective pixels included in each subject frame image. Such setting causes all the pixels included in each subject frame image to be detected as the pixel with motion. In the processing flow of the motion follow-up composition technique, the resolution enhancement module 110 accordingly generates pixel data of each target pixel G(j) from pixel data of pixels in the base frame image, which surround the target pixel G(j), by any of diverse interpolation techniques, for example, the bilinear method, the bicubic method, or the nearest neighbor method. The processing flow of the motion follow-up composition technique thus gives the practically equivalent processing result to that of the simple resolution enhancement.

When the motion rate Re determined by the motion detection module 108 is greater than the preset threshold value Rt2 but is not greater than the preset threshold value Rt1(Rt2<Re≦Rt1) in the selection of the resolution enhancement process (step S8 in FIG. 2), the processing flow executes the original motion follow-up composition described in the above embodiment.

In this modified example, the processing flow of the motion follow-up composition technique executes the series of processing practically equivalent to the motion non-follow-up composition and the series of processing practically equivalent to the simple resolution enhancement, in addition to the original motion follow-up composition by simply varying the width of the object range. The modified motion follow-up composition technique gives the similar processing results to those of the above embodiment that selectively executes the three available resolution enhancement processes.

In the processing flow of the motion follow-up composition technique that changes over the details of the resolution enhancement process, the width of the object range is varied in three different stages according to the determined motion rate Re. The width of the object range may be varied in four or more different stages or in a continuous manner.

For example, in the structure of varying the width of the object range in a continuous manner according to the determined motion rate Re, the width of the object range is gradually reduced as the motion rate Re approaches to 1. Such reduction increases the number of pixels detected as the pixel with motion in the motion detection process of the motion follow-up composition technique. This is equivalent to execution of the simple resolution enhancement with regard to a large number of pixels. The width of the object range is gradually enhanced as the motion rate Re approaches to 0. Such enhancement decreases the number of pixels detected as the pixel with motion in the motion detection process of the motion follow-up composition technique. This is equivalent to execution of the motion non-follow-up composition with regard to a large number of pixels.

The resolution enhancement process to be executed is thus adequately changed over from the simple resolution enhancement to the motion non-follow-up composition according to the motion rate Re. This arrangement ensures execution of the adequate resolution enhancement process with high accuracy according to the determined motion rate Re.

The procedure of the fourth embodiment sets a certain constituent pixel as the object pixel of the processing, selects an adequate resolution enhancement process in an object block including the object constituent pixel, and executes the selected resolution enhancement process with regard to constituent pixels included in the object block. The procedure repeats this series of processing to sequentially set all the constituent pixels as the object pixel, select an adequate resolution enhancement process for each object block including the object constituent pixel, and execute the selected resolution enhancement process with regard to the constituent pixels included in each object block. This procedure is, however, not restrictive at all. One possible modification may select an adequate resolution enhancement process for each block, set a certain constituent pixel as the object pixel, and execute the selected resolution enhancement process with regard to constituent pixels of an object block including the object pixel. The modified procedure repeats this series of processing to sequentially set all the constituent pixels as the object pixel and execute the selected resolution enhancement process with regard to the constituent pixels of each object block including the object pixel.

In this modified procedure of selecting an adequate resolution enhancement process for each block, setting a certain constituent pixel as the object pixel, and executing the selected resolution enhancement process with regard to constituent pixels of an object block including the object pixel, the constituent pixels may be set sequentially as the object pixel in the unit of each block. For example, constituent pixels in a next block are processed only after completion of processing with regard to all the pixels included in a certain block.

The procedure of the third embodiment sets a certain constituent pixel as the object pixel of the processing, selects an adequate resolution enhancement process in an object block including the object constituent pixel, and executes the selected resolution enhancement process with regard to constituent pixels included in the object block. The constituent pixels may be set sequentially as the object pixel in the unit of each block. For example, constituent pixels in a next block are processed only after completion of processing with regard to all the pixels included in a certain block.

The procedure of the above embodiment uses the three parameters, that is, the translational shifts (u in the lateral direction and v in the vertical direction) and the rotational shift (δ) to estimate the correction rates for eliminating the positional shifts in the whole image and in each block. This procedure is, however, not restrictive at all. For example, the correction rates may be estimated with only part of the three parameters, a greater number of parameters including additional parameters, or any other types of parameters.

Different numbers of parameters or different types of parameters may be used to estimate the correction rates for eliminating the positional shifts in the whole image and in each block. For example, the three parameters, that is, the translational shifts (u,v) and the rotational shift (δ), are used to estimate the correction rate of eliminating the positional shift in the whole image. Only the two parameters, that is, the translational shifts (u,v), may be used to estimate the correction rate of eliminating the positional shift in each block.

In the system of the third embodiment, the motion detection module 108 calculates the motion rate from the relative distance M (see FIG. 20) of the distance M2 relative to the distance M1. Such calculation is, however, not restrictive at all. The motion rate may be calculated, for example, from a relative distance of the distance M1 relative to the distance M2.

The procedure of the third embodiment divides each of the base frame image F0 and the subject frame images F1 to F3 into 12 blocks. The number of divisional blocks is, however, not limited to 12 but may be, for example, 6 or 24. The respective blocks of the base frame image F0 and the subject frame images F1 to F3 have similar shapes and dimensions in the above embodiment. The divisional blocks may, however, have different dimensions.

The procedure of the third embodiment calculates the moving distance of the center coordinates in a specified block of each of the subject frame images F1 to F3 relative to the base frame image F0 or the corresponding block in the base frame image F0. This procedure is, however, not restrictive at all. The procedure may calculate the moving distance of any arbitrary coordinates in a specified block of each of the subject frame images F1 to F3.

In the embodiments discussed above, the motion rate detection process (step S6 in FIG. 2) refers to all the subject frame images to determine the motion rate. This method is, however, not restrictive at all. The motion rate may be determined by referring to only one or multiple selected subject frame images. This modified procedure desirably lessens the amount of computation and shortens the processing time, compared with determination of the motion rate by referring to all the subject frame images.

In the motion rate detection method 1 of the first embodiment (see FIG. 11), the motion detection executed in the motion rate detection process (step S6 in FIG. 2) may be adopted to detect the motion or no motion of each object pixel Fpt included in the subject frame image Ft. The motion detection of the motion rate detection method 1 is then executed only for the object pixels Fpt detected as the pixel with no motion.

In the embodiments discussed above, the still image generation system obtains frame image data of 4 consecutive frames in a time series at the input timing of the frame image data acquisition command. This is, however, not restrictive at all. The frame image data obtained may represent another number of consecutive frames, that is, 2 consecutive frames, 3 consecutive frames, or not less than 5 consecutive frames. Relatively high-resolution still image data may be generated from part or all of the obtained frame image data as described previously.

In the embodiments discussed above, one high-resolution image data is generated from multiple consecutive frame image data in a time series among moving picture data. The technique of the invention is, however, not restricted to such image data. One high-resolution image data may be generated from any multiple consecutive low-resolution image data in a time series. The multiple consecutive low-resolution image data in the time period may be, for example, multiple continuous image data serially taken with a digital camera.

The multiple consecutive low-resolution image data (including frame image data) in the time series may be replaced by multiple low-resolution image data simply arrayed in the time series.

In the embodiments discussed above, the personal computer (PC) is used as the still image generation apparatus. The still image generation apparatus is, however, not limited to the personal computer (PC) but may be built in any of diverse devices, for example, video cameras, digital cameras, printers, DVD players, video tape players, hard disk players, and camera-equipped cell phones. A video camera with the built-in still image generation apparatus of the invention shoots a moving picture and simultaneously generates one high-resolution still image data from multiple frame image data included in moving picture data of the moving picture. A digital camera with the built-in still image generation apparatus of the invention serially takes pictures of a subject and generates one high-resolution still image data from multiple continuous image data of the serially taken pictures simultaneously with the continuous shooting or checking the results of continuous shooting.

The above embodiments regard frame image data as one example of relatively low-resolution image data. The technique of the invention is, however, not restricted to such frame image data. For example, field image data may replace the frame image data. Field images expressed by field image data in the interlacing technique include both a still image of odd fields and a still image of even fields, which are combined to form a composite image corresponding to a frame image in a non-interlacing technique.

Finally the present application claims the priority based on Japanese Patent Application No. 2003-339915 filed on Sep. 30, 2003 and Japanese Patent Application No. 2003-370279 on Oct. 30, 2003, which are herein incorporated by reference.

1. A still image generation method of generating higher-resolution second image data, which represents a resulting still image, from multiple lower-resolution first image data, the still image generation method comprising the steps of:
(a) correcting the multiple first image data to eliminate a positional shift between images of the multiple first image data;
(b) detecting a motion in each of the images of the multiple first image data, based on comparison of the multiple corrected first image data; and
(c) selecting one resolution enhancement process among multiple available resolution enhancement processes according to a result of the detection.

2. A still image generation method in accordance with claim 1, the still image generation method further comprising the step of:
(d) executing the selected resolution enhancement process to generate the higher-resolution second image data from the multiple corrected lower-resolution first image data.

3. A still image generation method in accordance with claim 1, the still image generation method further comprising the step of:
(d) notifying a user of the selected resolution enhancement process as a recommendation of resolution enhancement process.

4. A still image generation method in accordance with claim 1, wherein the multiple first image data are multiple image data that are extracted from moving picture data and are arrayed in a time series.

5. A still image generation method of generating higher-resolution second image data, which represents a resulting still image, from multiple lower-resolution first image data, the still image generation method comprising the steps of:
(a) correcting the multiple first image data to eliminate a positional shift between images of the multiple first image data;
(b) comparing base image data set as a standard with at least one subject image data other than the base image data among the multiple corrected first image data, detecting each localized motion in a subject image expressed by the at least one subject image data relative to a base image expressed by the base image data, and calculating a motion rate as a total sum of localized motions over the whole subject image; and
(c) selecting one resolution enhancement process among multiple available resolution enhancement processes according to the calculated motion rate.

6. A still image generation method in accordance with claim 5, the still image generation method further comprising the step of:
(d) executing the selected resolution enhancement process to generate the higher-resolution second image data from the multiple corrected lower-resolution first image data.

7. A still image generation method in accordance with claim 5, the still image generation method further comprising the step of:
(d) notifying a user of the selected resolution enhancement process as a recommendation of resolution enhancement process.

8. A still image generation method in accordance with claim 5, wherein the multiple first image data are multiple image data that are extracted from moving picture data and are arrayed in a time series.

9. A still image generation method in accordance with claim 5, wherein the step (b) detects a motion or no motion of each pixel included in the subject image relative to the base image, and calculates the motion rate from a total number of pixels detected as a pixel with motion.

10. A still image generation method in accordance with claim 9, wherein the step (b) sequentially sets each pixel in the subject image as an object pixel or an object of motion detection in the subject image relative to the base image, sets an object range of the motion detection based on a pixel value of a nearby pixel in the base image that is located near to the object pixel, and detects the object pixel as the pixel with motion when a pixel value of the object pixel is within the object range, while detecting the object pixel as a pixel with no motion when the pixel value of the object pixel is out of the object range.

11. A still image generation method in accordance with claim 9, wherein the step (b) sequentially sets each pixel in the subject image as an object pixel or an object of motion detection in the subject image relative to the base image, estimates an assumed pixel to have an identical pixel value with a pixel value of the object pixel based on a pixel value of a nearby pixel in the base image that is located near to the object pixel, and detects the object pixel as the pixel with motion when a distance between the object pixel and the assumed pixel is greater than a preset threshold value, while detecting the object pixel as a pixel with no motion when the distance is not greater than the preset threshold value.

12. A still image generation method in accordance with claim 5, wherein the step (b) computes a motion value of each pixel in the subject image, which represents a degree of motion of the pixel in the subject image relative to the base image, and calculates the motion rate from a total sum of the computed motion values.

13. A still image generation method in accordance with claim 12, wherein the step (b) sequentially sets each pixel in the subject image as an object pixel or an object of motion detection in the subject image relative to the base image, sets a reference pixel value based on a pixel value of a nearby pixel in the base image that is located near to the object pixel, and computes a difference between a pixel value of the object pixel and the reference pixel value as the motion value of the object pixel.

14. A still image generation method in accordance with claim 12, wherein the step (b) sequentially sets each pixel in the subject image as an object pixel or an object of motion detection in the subject image relative to the base image, estimates an assumed pixel to have an identical pixel value with a pixel value of the object pixel based on a pixel value of a nearby pixel in the base image that is located near to the object pixel, and computes a distance between the object pixel and the assumed pixel as the motion value of the object pixel.

15. A still image generation method of generating higher-resolution second image data, which represents a resulting still image, from multiple lower-resolution first image data, the still image generation method comprising the steps of:
(a) comparing base image data set as a standard with at least one subject image data other than the base image data among the multiple first image data, detecting a motion in a subject image expressed by the at least one subject image data relative to a base image expressed by the base image data with regard to each of multiple blocks obtained by dividing the subject image, and determining a motion rate, which represents a degree of motion in the whole subject image relative to the base image, based on a result of the motion detection; and
(b) selecting one resolution enhancement process among multiple available resolution enhancement processes according to the determined motion rate.

16. A still image generation method in accordance with claim 15, the still image generation method further comprising the step of:
(c) executing the selected resolution enhancement process to generate the second image data from the multiple first image data.

17. A still image generation method in accordance with claim 15, the still image generation method further comprising the step of:
(c) notifying a user of the selected resolution enhancement process as a recommendation of resolution enhancement process.

18. A still image generation method in accordance with claim 15, the still image generation method further comprising the step of:
(c) detecting a first positional shift of the whole subject image relative to the base image and second positional shifts of respective blocks included in the subject image relative to corresponding blocks of the base image,
wherein the step (a) detects a motion in a specified block, based on the detected first positional shift of the whole subject image and the detected second positional shift of the specified block.

19. A still image generation method in accordance with claim 15, wherein the step (a) detects a motion or no motion of each pixel included in a specified block of the subject image relative to a corresponding block of the base image, and detects a motion in the specified block, based on a total number of pixels detected as a pixel with motion.

20. A still image generation method in accordance with claim 15, wherein the step (a) computes a motion value of each pixel in a specified block of the subject image, which represents a magnitude of motion of the subject image relative to the base image, and detects a motion in the specified block, based on a total sum of the computed motion values.

21. A still image generation method in accordance with claim 15, wherein the step (a) calculates the motion rate from a total number of blocks detected as a block with motion.

22. A still image generation method in accordance with claim 15, wherein the step (a) calculates the motion rate from a total sum of magnitudes of motions detected in respective blocks.

23. A still image generation method in accordance with claim 15, wherein the multiple first image data are multiple image data that are extracted from moving picture data and are arrayed in a time series.

24. A still image generation method of generating higher-resolution second image data, which represents a resulting still image, from multiple lower-resolution first image data, the still image generation method comprising the steps of:
(a) comparing base image data set as a standard with at least one subject image data other than the base image data among the multiple first image data, detecting a motion in a subject image expressed by the at least one subject image data relative to a base image expressed by the base image data with regard to each of multiple blocks obtained by dividing the subject image, and determining an in-block motion rate of each block of the subject image, which represents a degree of motion in the block of the subject image relative to a corresponding block of the base image, based on a result of the motion detection;
(b) selecting one resolution enhancement process for each block among multiple available resolution enhancement processes according to the determined in-block motion rate; and
(c) executing the resolution enhancement process selected for each block, so as to generate the second image data representing the block of the resulting still image from the multiple first image data.

25. A still image generation method in accordance with claim 24, the still image generation method further comprising the step of:
(d) detecting a first positional shift of the whole subject image relative to the base image and second positional shifts of respective blocks included in the subject image relative to corresponding blocks of the base image,
wherein the step (a) detects a motion in a specified block, based on the detected first positional shift of the whole subject image and the detected second positional shift of the specified block.

26. A still image generation method in accordance with claim 24, wherein the step (a) detects a motion or no motion of each pixel included in a specified block of the subject image relative to a corresponding block of the base image, and detects a motion in the specified block, based on a total number of pixels detected as a pixel with motion.

27. A still image generation method in accordance with claim 24, wherein the step (a) computes a motion value of each pixel in a specified block of the subject image, which represents a magnitude of motion of the subject image relative to the base image, and detects a motion in the specified block, based on a total sum of the computed motion values.

28. A still image generation method in accordance with claim 24, wherein the multiple first image data are multiple image data that are extracted from moving picture data and are arrayed in a time series.

29. A still image generation apparatus that generates higher-resolution second image data, which represents a resulting still image, from multiple lower-resolution first image data, the still image generation apparatus comprising:
a shift correction module that corrects the multiple first image data to eliminate a positional shift between images of the multiple first image data;
a motion detection module that detects a motion in each of the images of the multiple first image data, based on comparison of the multiple corrected first image data; and
a resolution enhancement process selection module that selects one resolution enhancement process among multiple available resolution enhancement processes according to a result of the detection.

30. A still image generation apparatus that generates higher-resolution second image data, which represents a resulting still image, from multiple lower-resolution first image data, the still image generation apparatus comprising:
a shift correction module that corrects the multiple first image data to eliminate a positional shift between images of the multiple first image data;
a motion detection module that compares base image data set as a standard with at least one subject image data other than the base image data among the multiple corrected first image data, detects each localized motion in a subject image expressed by the at least one subject image data relative to a base image expressed by the base image data, and calculates a motion rate as a total sum of localized motions over the whole subject image; and
a resolution enhancement process selection module that selects one resolution enhancement process among multiple available resolution enhancement processes according to the calculated motion rate.

31. A still image generation apparatus that generates higher-resolution second image data, which represents a resulting still image, from multiple lower-resolution first image data, the still image generation apparatus comprising:
a motion detection module that compares base image data set as a standard with at least one subject image data other than the base image data among the multiple first image data, detects a motion in a subject image expressed by the at least one subject image data relative to a base image expressed by the base image data with regard to each of multiple blocks obtained by dividing the subject image, and determines a motion rate, which represents a degree of motion in the whole subject image relative to the base image, based on a result of the motion detection; and
a resolution enhancement process selection module that selects one resolution enhancement process among multiple available resolution enhancement processes according to the determined motion rate.

32. A still image generation apparatus that generates higher-resolution second image data, which represents a resulting still image, from multiple lower-resolution first image data, the still image generation apparatus comprising:
a motion detection module that compares base image data set as a standard with at least one subject image data other than the base image data among the multiple first image data, detects a motion in a subject image expressed by the at least one subject image data relative to a base image expressed by the base image data with regard to each of multiple blocks obtained by dividing the subject image, and determines an in-block motion rate of each block of the subject image, which represents a degree of motion in the block of the subject image relative to a corresponding block of the base image, based on a result of the motion detection;
a resolution enhancement process selection module that selects one resolution enhancement process for each block among multiple available resolution enhancement processes according to the determined in-block motion rate; and
a resolution enhancement module that executes the resolution enhancement process selected for each block, so as to generate the second image data representing the block of the resulting still image from the multiple first image data.

33. A computer program product used to generate higher-resolution second image data, which represents a resulting still image, from multiple lower-resolution first image data, the computer program product comprising:
a first program code of correcting the multiple first image data to eliminate a positional shift between images of the multiple first image data;
a second program code of detecting a motion in each of the images of the multiple first image data, based on comparison of the multiple corrected first image data;
a third program code of selecting one resolution enhancement process among multiple available resolution enhancement processes according to a result of the detection; and
a computer readable medium to store the first through the third program codes.

34. A computer program product used to generate higher-resolution second image data, which represents a resulting still image, from multiple lower-resolution first image data, the computer program product comprising:
a first program code of correcting the multiple first image data to eliminate a positional shift between images of the multiple first image data;
a second program code of comparing base image data set as a standard with at least one subject image data other than the base image data among the multiple corrected first image data, detecting each localized motion in a subject image expressed by the at least one subject image data relative to a base image expressed by the base image data, and calculating a motion rate as a total sum of localized motions over the whole subject image;
a third program code of selecting one resolution enhancement process among multiple available resolution enhancement processes according to the calculated motion rate; and
a computer readable medium to store the first through the third program codes.

35. A computer program product used to generate higher-resolution second image data, which represents a resulting still image, from multiple lower-resolution first image data, the computer program product comprising:
a first program code of comparing base image data set as a standard with at least one subject image data other than the base image data among the multiple first image data, detecting a motion in a subject image expressed by the at least one subject image data relative to a base image expressed by the base image data with regard to each of multiple blocks obtained by dividing the subject image, and determining a motion rate, which represents a degree of motion in the whole subject image relative to the base image, based on a result of the motion detection;
a second program code of selecting one resolution enhancement process among multiple available resolution enhancement processes according to the determined motion rate; and
a computer readable medium to store the first and second program codes.

36. A computer program product used to generate higher-resolution second image data, which represents a resulting still image, from multiple lower-resolution first image data, the computer program product comprising:
a first program code of comparing base image data set as a standard with at least one subject image data other than the base image data among the multiple first image data, detecting a motion in a subject image expressed by the at least one subject image data relative to a base image expressed by the base image data with regard to each of multiple blocks obtained by dividing the subject image, and determining an in-block motion rate of each block of the subject image, which represents a degree of motion in the block of the subject image relative to a corresponding block of the base image, based on a result of the motion detection;
a second program code of selecting one resolution enhancement process for each block among multiple available resolution enhancement processes according to the determined in-block motion rate;
a third program code of executing the resolution enhancement process selected for each block, so as to generate the second image data representing the block of the resulting still image from the multiple first image data; and
a computer readable medium to store the first through the third program codes.
